(19) United States
(12) Patent Application Publication
(10) Pub. No.: US 2026/0260432 A1
(43) Pub. Date: Sep. 3, 2026

(54) INFORMATION PROCESSING DEVICE, CONTROL METHOD, AND STORAGE MEDIUM

(71) Applicant: NEC Corporation, Minato-ku, Tokyo (JP)

(72) Inventor: Ryosuke SAKAI, Tokyo (JP)

(73) Assignee: NEC Corporation, Minato-ku, Tokyo (JP)

(21) Appl. No.: 18/718,495

(22) PCT Filed: Dec. 21, 2021
(86) PCT No.: PCT/JP2021/047293

§ 371 Date: Jun. 11, 2024

(51) Int. Cl. G06T 19/00; G06T 7/73

(52) U.S. Cl. CPC G06T 19/006; G06T 7/73; G06T 2207/20081; G06T 2219/004

(57) ABSTRACT

The structural data acquisition means 46X acquires first structural data regarding a first feature point group to be extracted from a target field, and second structural data regarding a second feature point group. The feature point information acquisition means 42X acquires feature point information indicating a position on an image and a candidate label indicating correspondence to the first feature point group, determined based on the image including the at-least-partial field. The label correction means 53X identifies, based on the second structural data, the position on the image and the candidate label corresponding to the second feature point group, and generate corrected feature point information with a corrected label indicating the second feature point group. The field estimation means 54X estimates, based on the first and second structural data, and the corrected feature point information, the field in a coordinate system referenced by a display device with a camera.

### TECHNICAL FIELD

The present invention relates to a technical field of an information processing device, a control method, and a storage medium configured to perform processing related to space recognition in augmented reality (AR: Augmented Reality).

### BACKGROUND

Regarding a device that provides augmented reality, there is a technique for determining a display position of an image (so-called AR image) superimposed on a scenery that is visually recognized by a user based on an image captured by a camera. For example, Patent Literature 1 discloses a technique of estimating the positions of respective feature points of a field and calibrating an AR setting based on the estimate in order to realize AR in sports viewing.

### CITATION LIST

### Patent Literature

Patent Literature 1: WO2021/033314

### SUMMARY

### Problem to be Solved

When a process such as calibration by extracting feature points of the field of interest is performed as in Patent Literature 1, the extraction accuracy of the feature points will affect the accuracy of the subsequent calibration process. In addition, there is a case in which a target field of training of feature point extraction does not completely match a target field of an AR display in terms of the specifications and/or features, and in such a case, there is a possibility that extraction accuracy of the feature points could deteriorate.

In view of the above-described issue, it is therefore an example object of the present disclosure to provide an information processing device, a control method, and a storage medium capable of suitably estimating a field based on feature point information obtained through feature point extraction.

### Means for Solving the Problem

In one mode of the information processing device, there is provided an information processing device including:
a structural data acquisition means configured to acquire
   first structural data regarding a first feature point group defined as feature points to be extracted from a target field, and
   second structural data regarding a second feature point group other than the first feature point group;
a feature point information acquisition means configured to acquire feature point information indicating sets of a position on an image and a candidate label thereof indicating a correspondence to a feature point of the first feature point group,
   the sets being determined based on the image which includes at least a part of the field;
a label correction means configured to
   identify, based on the second structural data, a set of the position on the image and the candidate label corresponding to a feature point of the second feature point group, and
   generate corrected feature point information in which the identified candidate label is corrected to be a label indicating the feature point of the second feature point group; and
a field estimation means configured to estimate,
   based on the first structural data, the second structural data, and the corrected feature point information,
   the field in a coordinate system to be used as a reference by a display device, which is equipped with a camera for capturing the image.

In one mode of the control method, there is provided a control method executed by a computer, the control method including:
acquiring
   first structural data regarding a first feature point group defined as feature points to be extracted from a target field, and
   second structural data regarding a second feature point group other than the first feature point group;
acquiring feature point information indicating sets of a position on an image and a candidate label thereof indicating a correspondence to a feature point of the first feature point group,
   the sets being determined based on the image which includes at least a part of the field;
identifying, based on the second structural data, a set of the position on the image and the candidate label corresponding to a feature point of the second feature point group, and
generating corrected feature point information in which the identified candidate label is corrected to be a label indicating the feature point of the second feature point group; and
estimating,
   based on the first structural data, the second structural data, and the corrected feature point information,
   the field in a coordinate system to be used as a reference by a display device, which is equipped with a camera for capturing the image.

In one mode of the storage medium, there is provided a storage medium storing a program executed by a computer, the program causing the computer to:
acquire
   first structural data regarding a first feature point group defined as feature points to be extracted from a target field, and
   second structural data regarding a second feature point group other than the first feature point group;
acquire feature point information indicating sets of a position on an image and a candidate label thereof indicating a correspondence to a feature point of the first feature point group,
   the sets being determined based on the image which includes at least a part of the field;
identify, based on the second structural data, a set of the position on the image and the candidate label corresponding to a feature point of the second feature point group, and
generate corrected feature point information in which the identified candidate label is corrected to be a label indicating the feature point of the second feature point group; and
estimate,
   based on the first structural data, the second structural data, and the corrected feature point information,
   the field in a coordinate system to be used as a reference by a display device, which is equipped with a camera for capturing the image.

### Effect

An example advantage according to the present invention is to accurately estimate the field based on the corrected feature point information.

### BRIEF DESCRIPTION OF THE DRAWINGS

FIG. 1 It is a schematic configuration diagram of a display device according to a first example embodiment.

FIG. 2 It is a block diagram showing a functional configuration of a control unit.

FIGS. 3A and 3B FIG. 3A illustrates a first label definition example of the first structural feature point group in the training field which is a tennis court.

FIG. 3B illustrates label definition examples of the first structural feature point group and the second structural feature point group in the display target field which is a tennis court.

FIGS. 4A and 4B FIG. 4A illustrates the first label definition example of the first structural feature point group in the training field which is a pool.

FIG. 4B illustrates the first label definition examples of the first structural feature point group and the second structural feature point group in the display target field that is a pool.

FIGS. 5A and 5B FIG. 5A illustrates the second label definition example of the first structural feature point group and the second structural feature point group in the display target field that is a tennis court.

FIG. 5B illustrates the second label definition examples of the first structural feature point group and the second structural feature point group in the display target field that is a pool.

FIG. 6 It is an example of a functional block of a field estimation unit.

FIG. 7 It is an example of a functional block of a feature point error detection unit.

FIG. 8 It illustrates the positional relation between the device coordinate system and the field coordinate system after adjustment such that the axes of the device coordinate system and the field coordinate system in the height direction are parallel.

FIG. 9 It illustrates the device coordinate system and the field coordinate system with indications of the photographing position by a camera, the captured image, and the display target field.

FIG. 10 It illustrates the device coordinate system with an indication of the clustering results of the generated six candidate fields.

FIG. 11 It illustrates the device coordinate system with an indication of estimated position of the display target field obtained through the optimization process based on the extracted feature positions other than extracted error feature positions.

FIGS. 12A and 12B FIG. 12A illustrates the estimated field plane with an indication of the extracted feature positions associated with the candidate label numbers in the case where the display target field is a tennis court.

FIG. 12B illustrates the estimated field plane with an indication of sets of an extracted feature position and its candidate label after the candidate label correction by a first correction unit.

FIGS. 13A and 13B FIG. 13A illustrates the estimated field plane with an indication of the extracted feature positions associated with the candidate label numbers in the case where the display target field is a tennis court.

FIG. 13B illustrates the estimated field plane with an indication of sets of an extracted feature position and its candidate label after the candidate label correction by a second correction unit.

FIG. 14 It is a diagram showing a correspondence between structural feature points and labels when a pool equipped with a long float in its center is used as a training field and a display target field.

FIG. 15 It is an example of a flowchart showing a processing outline related to the display process of virtual objects to be executed by the control unit in the first example embodiment.

FIG. 16 It is an example of a flowchart showing a detailed processing procedure of the calibration process.

FIG. 17 It is an example of a flowchart indicative of the details of the the feature point error detection process executed at step S22.

FIG. 18 It is an example of a flowchart showing the details of the first label correction process.

FIG. 19 It is an example of a flowchart showing the details of the second label correction process.

FIG. 20 It illustrates a configuration of a display system in a second example embodiment.

FIG. 21 It is a block diagram of a server device in the second example embodiment.

FIG. 22 It is an example of a flowchart indicative of a processing procedure to be executed by the control unit of the server device in the second example embodiment.

FIG. 23 It illustrates a schematic configuration of an information processing device according to a third example embodiment.

FIG. 24 It is an example of a flowchart in the third example embodiment.

### EXAMPLE EMBODIMENTS

Hereinafter, example embodiments of an information processing device, a control method, and a storage medium will be described with reference to the drawings.

### First Example Embodiment

### (1) Schematic Configuration

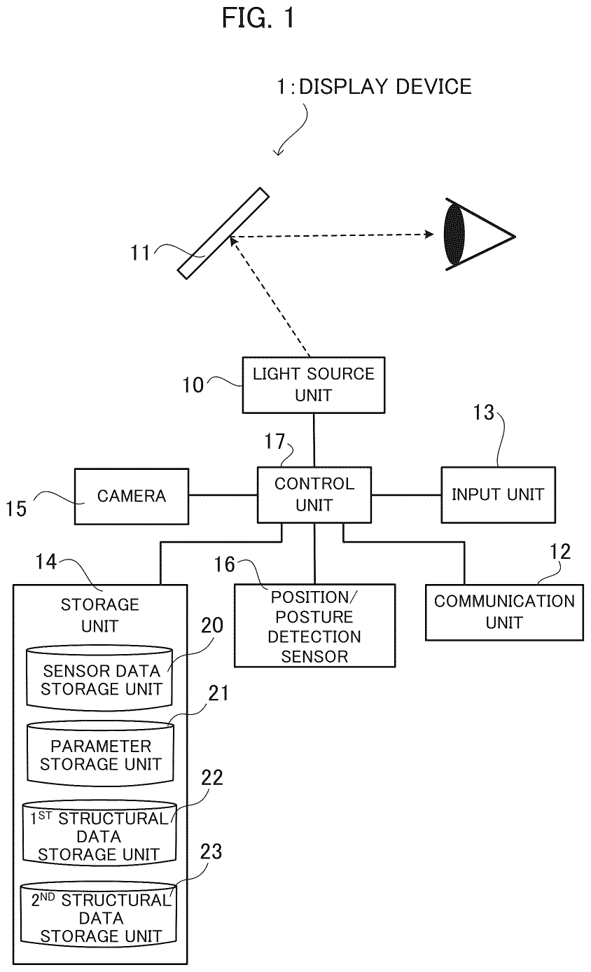

FIG. 1 is a schematic configuration diagram of a display device 1 according to the first example embodiment. The display device 1 is a device which can be worn by a user, such as a see-through device configured as an eyeglass, and is configured to be worn on a user's head. In addition, the display device 1 provides augmented reality (AR: Augmented Reality) by displaying visual information superimposed on a real scene in watching a sports event or a play (including a concert). The above-described visual information is a two-dimensional or three-dimensional virtual object and is also referred to as “virtual object” hereinafter. The display device 1 may display the virtual object only in one eye of the user, or may display the virtual object in both eyes.

In the present example embodiment, it is herein assumed that there is a place or a structure (also referred to as “field” hereafter) in which sports or a play is performed, and the display device 1 superimposes and displays, on or around the field, a virtual object indicative of additional information for assisting the user to watch sports or theatrical plays. Examples of the virtual object include a score board to be displayed above a tennis court in the case of tennis, a world recording line to be superimposed in real-time on a pool during a swimming competition, and a virtual performer to be superimposed on a stage in a theater.

The field includes a plurality of structural, i.e., characteristic in shape, feature points (also referred to as “structural feature points”). Examples of the field include a target field (e.g., tennis courts, swimming pools, and stadiums) of sports viewing, a target field (e.g., theatres, concert halls, multi-purpose halls, and any other stages) of a play. The field serves as a reference in the calibration of the display device 1.

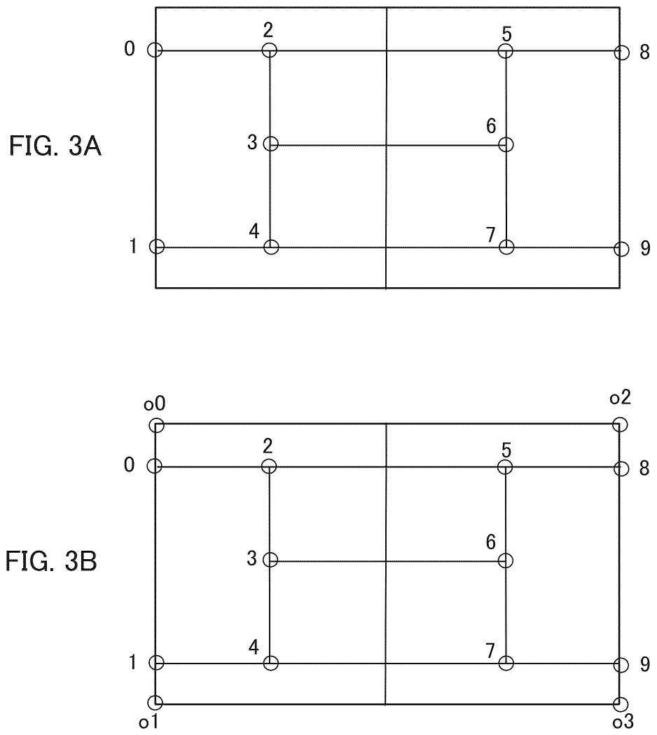

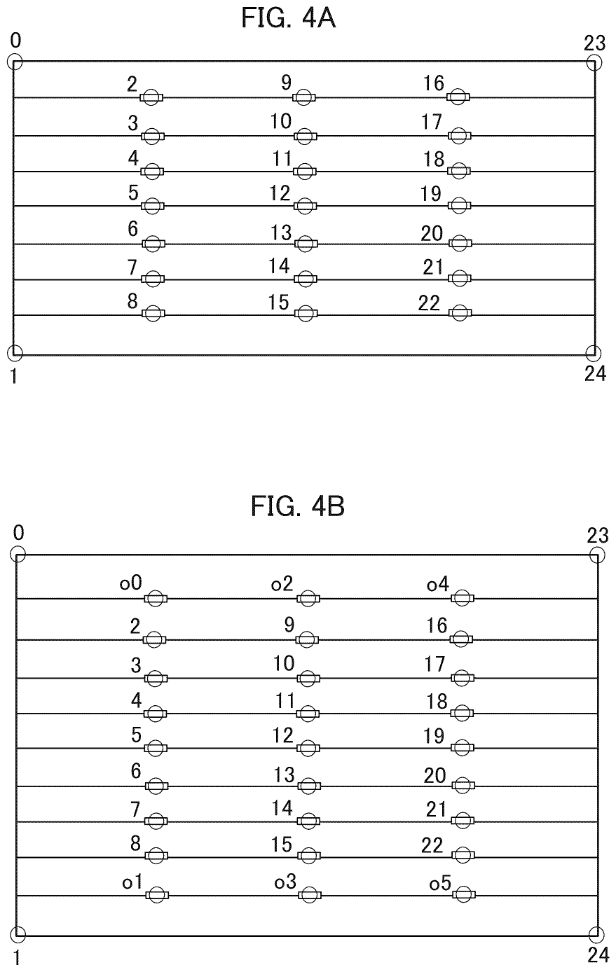

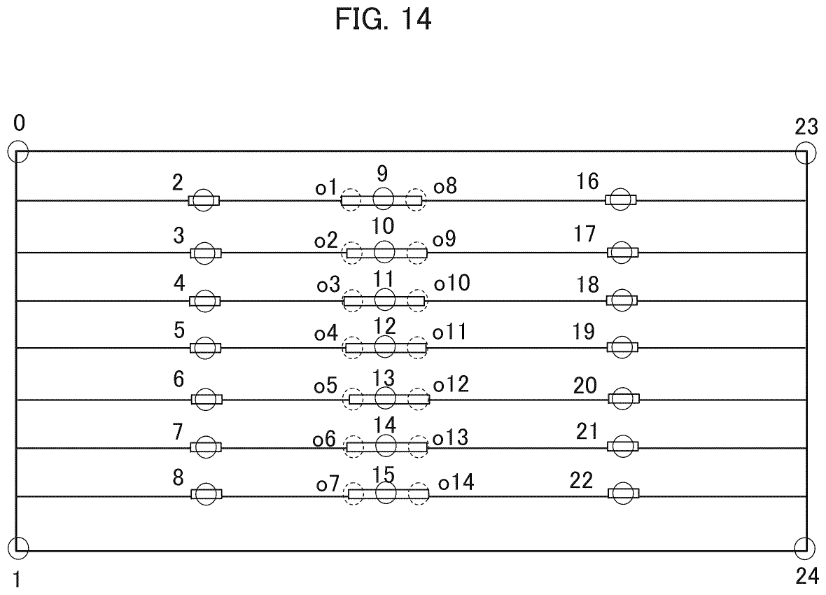

Further, in the present example embodiment, an accurate calibration process is provided even when there is a partial difference in the specification between the field displayed on an image used in the training phase of the feature extraction process for extracting the structural feature points on the image and the field included in an image captured by the display device 1 in the display phase by the display device 1. Hereafter, the field displayed on the image used in the training phase of the feature extraction process is referred to as “training field”, and the field included in the image captured by the display device 1 in the calibration process is referred to as “display target field”. As described later, the display target field is a field that is used for the same purpose as the training field, and includes at least structural feature points included in the training field, and optionally includes structural feature point(s) that are not included in the training field. For example, the training field is a field corresponding to a particular type of sports, and the display target field is a field corresponding to multiple types of sports. Other examples will be also described later with reference to FIG. 4A and FIG. 4B. The training field and the display target field may be identical in the specification. In this case, for example, in the training phase of the feature extraction process, any feature point to which a label was not given are labeled in the calibration process. This example will be described later with reference to FIG. 3A, FIG. 3B, and FIG. 14. It is noted that “two fields are identical in the specification” means that the two fields have the same number of corresponding structural feature points.

Hereafter, a set of labeled structural feature points of the field in the training phase of the feature extraction process is referred to as the “first structural feature point group”. A set of structural feature points of the field that are not subject to labeling in the above training phase but subject to labeling in the calibration process is referred to as “second structural feature point group”. Further, hereafter, it is assumed that the first structural feature point group includes “N1” number of structural feature points (N1 is an integer of 2 or more), and that the second structural feature point group includes “N2” number of structural feature points (N2 is an integer of 1 or more).

The display device 1 includes a light source unit 10, an optical element 11, a communication unit 12, an input unit 13, a storage unit 14, a camera 15, a position/posture detection sensor 16, and a control unit 17.

The light source unit 10 is equipped with one or more light sources such as a laser light source and a LCD (Liquid Crystal Display) light source, and emits light based on the driving signal supplied from the control unit 17. The optical element 11 with a predetermined transmittance transmits at least a portion of the incoming light to the user's eye while reflecting at least a portion of the incoming light from the light source unit 10 toward the user's eye. Thereby, the virtual image corresponding to the virtual object formed by the display device 1 overlaps with the scenery and is visually recognized by the user. The optical element 11 may be a half mirror with substantially equal transmittance and reflectance, or be a mirror (so-called beam splitter) such that the transmittance and reflectance are not equal.

The communication unit 12 exchanges data with an external device under the control of the control unit 17. For example, when the user uses the display device 1 for sports viewing or theater viewing or the like, the communication unit 12 receives, under the control of the control unit 17, information on the virtual object to be displayed by the display device 1 from a server device managed by a promoter.

The input unit 13 generates and transmits an input signal based on the operation of the user to the control unit 17. Examples of the input unit 13 include a button for the user to give an instruction to the display device 1, a four-way key, and a voice input device.

The camera 15 generates, under the control of the control unit 17, an image captured ahead of the display device 1, and supplies the generated image (also referred to as “captured image Im”) to the control unit 17.

The position/posture detection sensor 16 is one or more sensors (sensor group) for detecting the position and the posture (orientation) of the display device 1. For example, the position/posture detection sensor 16 includes one or more positioning sensors, such as a GPS (Global Positioning Satellite) receiver, and one or more posture detection sensors for detecting relative change in the posture of the display device 1, such as a gyroscope sensor, an accelerometer, an IMU (Inertial Measurement Unit). The position/posture detection sensor 16 supplies a generated detection signal relating to the position and posture of the display device 1 to the control unit 17. As will be described later, based on the detection signal supplied from the position/posture detection sensor 16, the control unit 17 detects the amount of change in the position and posture from the startup or the like of the display device 1. Instead of detecting the position of the display device 1 from the positioning sensor, the control unit 17 may specify the position of the display device 1 based on a signal received from a beacon terminal or a radio LAN device provided in the venue, for example. In another example, the control unit 17 may identify the position of the display device 1 based on a known position estimation technique using AR markers. In these cases, the position/posture detection sensor 16 may not include the positioning sensor.

The control unit 17 includes one or more processors, such as a CPU (Central Processing Unit), a GPU (Graphics Processing Unit), and one or more volatile memories that function as a working memory of the processors, and performs overall control of the display device 1.

For example, at the timing of displaying the virtual object, the control unit 17 performs a calibration process for associating the real-world space with the space recognized by the display device 1, on the basis of the structural feature points of the display target field recognized from the captured image Im. In this calibration process, the control unit 17 generates coordinate transformation information for transforming a position in a coordinate system (referred to as “device coordinate system”) in the three-dimensional space used as a reference (basis) by the display device 1 into a position in a coordinate system (referred to as “field coordinate system”) in the three-dimensional space in which the display target field is used as a reference (basis). The device coordinate system is an example of the “first coordinate system”, and the field coordinate system is an example of the “second coordinate system”. Details of the calibration process will be described later. Then, based on the coordinate transformation information or the like described above, the control unit 17 generates a driving signal for driving the light source unit 10, and then supplies the driving signal to the light source unit 10 to thereby cause the optical element 11 to emit light (referred to as “display light”) for displaying a virtual object. Thus, the control unit 17 enables the user to see the virtual object.

The storage unit 14 is one or more non-volatile memories which store various information necessary for the control unit 17 to control the display device 1. The storage unit 14 may include a removable storage medium such as a flash memory. Further, the storage unit 14 stores a program to be executed by the control unit 17.

The storage unit 14 includes a sensor data storage unit 20, a parameter storage unit 21, a first structural data storage unit 22, and a second structural data storage unit 23.

The sensor data storage unit 20 stores each captured image Im generated by the camera 15 in association with the amount (also referred to as “position/posture change amount Ap”) of change in the position and the posture of the display device 1 from the time (e.g., at the start time of the display device 1) of setting the device coordinate system to the time of generation of the captured image Im. In this case, for example, based on the detection signal from the position/posture detection sensor 16, the control unit 17 constantly calculates the amount of change from the position and the posture at the time of setting the device coordinate system to the current position and posture. When storing the captured image Im generated by the camera 15 in the sensor data storage unit 20, The control unit 17 stores the position/posture change amount Ap at the generation of the captured image Im in association with the captured image Im in the sensor data storage unit 20. For example, the control unit 17 stores captured images Im obtained during most recent predetermined period or a predetermined number of captured images Im and their position/posture change amounts Ap in the sensor data storage unit 20. The information stored in the sensor data storage unit 20 is used in the calibration process.

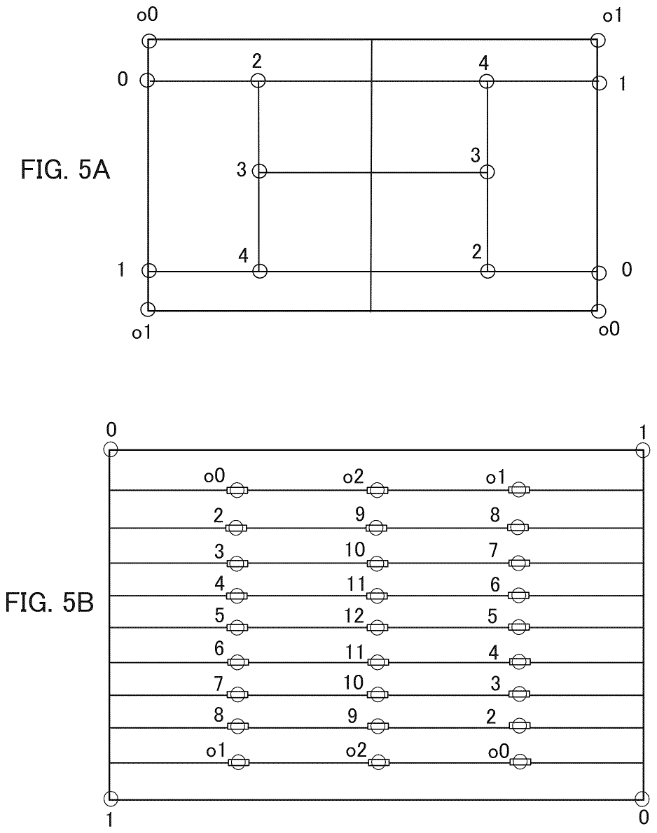

The parameter storage unit 21 stores parameters of an inference engine (also referred to as “feature extractor”) used in extracting the position information of the structural feature points of the display target field and the classification information of the structural feature points from the captured image Im in the calibration process. The above-described feature extractor is a learning model that learned to output, when an image is inputted thereto, position information of a structural feature point in the image for each class (i.e., label number) of the target structural feature points of extraction. The above-described position information may be map information on the image indicating the reliability as the structural feature point for every coordinate value or may be a coordinate value indicating the position of the structural feature point in the image per pixel or sub-pixel. When the above-described feature extractor outputs the map information for each class of the structural feature points, for example, the coordinate values with the top m (m is an integer of 1 or more) reliabilities which exceed a threshold value for each class of the structural feature points are adopted as positions of structural feature points. The above-described integer m becomes “1” in a label definition example (see FIGS. 3A and 3B and FIGS. 4A and 4B described below) in which a unique label is assigned to each structural feature point, and becomes “2” in a label definition example (see FIGS. 5A and 5B described below) in which a label is assigned in common to structural feature points in symmetrical positions. The learning model used for training the feature extractor may be a learning model based on a neural network, or may be another type of learning model such as a support vector machine, or may be a combination thereof. For example, when the above-described learning model is a neural network such as a convolutional neural network, the parameter storage unit 21 stores various parameters such as the layer structure, the neuron structure of each layer, the number of filters and the filter size in each layer, and the weight for each element of each filter. As described above, an image including the training field is used as an image for training the feature extractor.

The parameter storage unit 21 stores parameters related to the camera 15, such as the focal length of the camera 15, the internal parameters, the main point, and the size information of the captured image Im, which are required for displaying the virtual object.

The first structural data storage unit 22 stores the first structural data. The first structural data includes information on the structure of N1 structural feature points belonging to the first structural feature point group. Specifically, the first structural data includes at least a label indicating the classification (class) of each structural feature point belonging to the first structural feature point group and registered position information indicating the position of each structural feature point belonging to the first structural feature point group in the field coordinate system. The registered position information is coordinate information represented by a field coordinate system, and the position of one of the structural feature points is set as the origin of the field coordinate system, for example.

The second structural data storage unit 23 stores the second structural data. The second structural data includes information on the structure of N2 structural feature points belonging to the second structural feature point group. Specifically, the second structural data includes at least a label indicating the class of each structural feature point belonging to the second structural feature point group and registered position information indicating the position, in the field coordinate system, of each structural feature point belonging to the second structural feature point group. The length between any two points of the structural feature points of the first structural feature point group and the second structural feature point group can be calculated based on the coordinate values indicated by the registered position information. The first structural data and the second structural data are used in the calibration process.

The storage unit 14 may store various information in addition to the respective information described above. For example, the storage unit 14 may include information related to the size of the display target field, information which designates a structural feature point as the origin in the field coordinate system, and information which identifies each direction of the three axes of the field coordinate system, and the like. Further, the storage unit 14 may store the anisotropic information regarding the anisotropy of the displacement over time of the structural feature points of the field. For example, the anisotropic information indicates the easy-to-displace direction or/and the difficult-to-displace direction (and the degree) when the structural feature points of the field are displaced over time. These directions may be represented by vectors in the field coordinate system, for example, or may be identified based on the positional relation between structural feature points, such as “direction from the structural feature point A to the structural feature point B”.

The configuration of the display device 1 shown in FIG. 1 is an example, and various changes may be made to this configuration. For example, the display device 1 may be further equipped with a speaker for outputting sound under the control of the control unit 17. Further, the display device 1 may include a gaze detection camera for switching the display and non-display of the virtual object and/or changing the display position of the virtual object in accordance with the position of the user's gaze. In yet another example, the storage unit 14 may not include the sensor data storage unit 20. In this instance, the control unit 17 performs a calibration process using the captured image Im immediately acquired from the camera 15 and the position/posture change amount Ap calculated based on the detection signal of the position/posture detection sensor 16.

In yet another example, the display device 1 may not detect the position of the display device 1 by the position/posture detection sensor 16 or the like. Generally, during sports viewing or a theater viewing, it is rare for the user to move, and thus the influence on the display of the virtual object due to the change in the position of the display device 1 is smaller than the influence due to the change in the posture of the display device 1. In view of the above, the position/posture detection sensor 16 may be equipped with sensors for detecting the posture of the display device 1 so that the control unit 17 calculate, as the position/posture change amount Ap, only the amount of change in the posture of the display device 1 from the time of setting the device coordinate system.

### (2) Functional Blocks

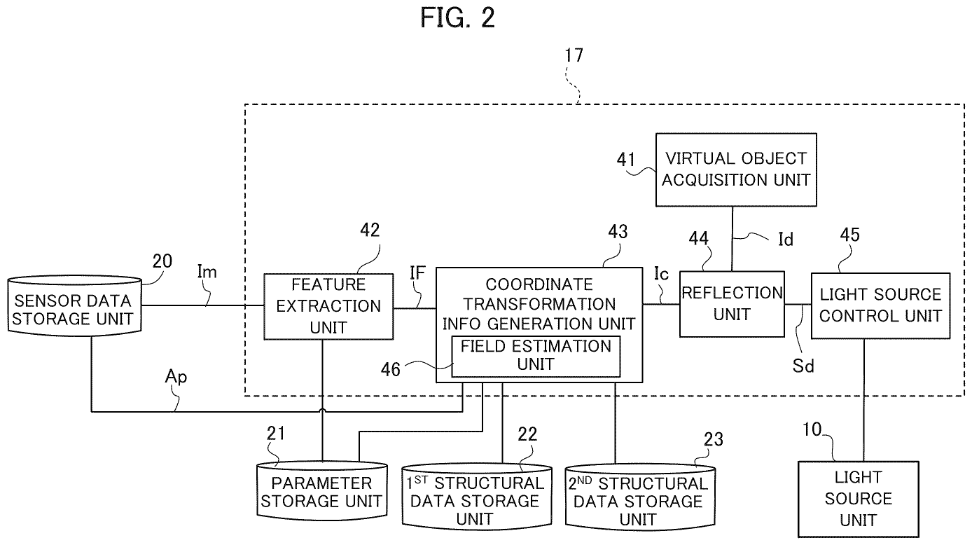

FIG. 2 is a block diagram showing a functional configuration of the control unit 17. As shown in FIG. 2, the control unit 17 functionally includes a virtual object acquisition unit 41, a feature extraction unit 42, a coordinate transformation information generation unit 43, a reflection unit 44, and a light source control unit 45. In FIG. 2, blocks to exchange data with each other are connected by a solid line, but the combination of blocks to exchange data with each other is not limited to the combination in FIG. 2. The same applies to the drawings of other functional blocks described below.

The virtual object acquisition unit 41 acquires information (also referred to as “specified display information Id”) specifying the virtual object and the display position of the virtual object to be superimposed on the scenery. The virtual object may be information (two-dimensional drawing information) for drawing a two-dimensional object, or information (three-dimensional drawing information) for drawing a three-dimensional object. For example, when the display device 1 are capable of communicating with a server device managed by a promoter, the virtual object acquisition unit 41 acquires distribution information distributed according to a push-type distribution or pull-type distribution from the server device at a predetermined timing as the specified display information Id. In this case, the specified display information Id includes information specifying not only the virtual object but also the display position (e.g., information indicating the coordinate value in the field coordinate system). In another example, information indicating a combination of the virtual object and the display position and the display condition thereof may be previously stored in the storage unit 14. In this case, upon determining that the stored display condition is satisfied, the virtual object acquisition unit 41 acquires the combination of the virtual object and its display position corresponding to the satisfied display condition as the specified display information Id.

The feature extraction unit 42 generates feature point information “IF” based on the captured image Im acquired from the sensor data storage unit 20. In this instance, the feature extraction unit 42 inputs the captured image Im (e.g., the newest captured image Im) to the feature extractor configured on the basis of the parameters extracted from the parameter storage unit 21 and then generates the feature point information IF from the information outputted by the feature extractor. For example, in this instance, the feature extractor outputs the positions (e.g., the coordinate values) of the structural feature points on the input captured image Im for respective labels indicating classes of the structural feature points, and the feature extraction unit 42 generates the feature point information IF indicating the combination of the positions (also referred to as “extracted feature positions”) on the captured image Im outputted by the feature extractor and candidates (also referred to as “candidate labels”) for the labels corresponding to the respective positions. If the feature extractor outputs the normalized values not depending on the image size as the coordinate values of the structural feature points, the feature extraction unit 42 calculates the extracted feature positions by multiplying the coordinate values by the image size of the captured image Im.

On the basis of the first structural data, the second structural data, the feature point information IF, the position/posture change amount Ap when the captured image Im subjected to the feature extraction is generated, and the parameters of the camera 15, the coordinate transformation information generation unit 43 generates coordinate transformation information “Ic” between the device coordinate system and the field coordinate system. For example, the coordinate transformation information Ic is a combination of a rotational matrix and a translation vector which are generally used to perform coordinate transformation between three-dimensional spaces. The coordinate transformation information Ic is not limited to the information used when transforming a position in the field coordinate system into a position in the device coordinate system, and it may be information used when transforming a position in the device coordinate system into a position in the field coordinate system. It is noted that the rotation matrix and the translation vector for transforming a position in the field coordinate system into a position in the device coordinate system can be transformed into a rotation matrix (the inverse of the rotation matrix described above) and a translation vector (the translation vector described above with sign inversion) for transforming a position in the device coordinate system into a position in the field coordinate system.

The coordinate transformation information generation unit 43 includes a field estimation unit 46. The field estimation unit 46 estimates the position of the display target field in the device coordinate system. The estimation method by the field estimation unit 46 will be described later. The coordinate transformation information generation unit 43 generates the coordinate transformation information Ic based on the position of the display target field in the device coordinate system estimated by the field estimation unit 46 and the position of the display target field in the field coordinate system, which is identified based on the first structural data and the second structural data.

The reflection unit 44 reflects the coordinate transformation information Ic supplied from the coordinate transformation information generation unit 43 in the specified display information Id supplied from the virtual object acquisition unit 41 to thereby generate a display signal “Sd” indicating a virtual object to be projected on the optical element 11. In this instance, the reflection unit 44 generates the display signal Sd based on the specified display information Id after matching the device coordinate system with the field coordinate system by the coordinate transformation information Ic. Based on the display signal Sd supplied from the reflection unit 44, the light source control unit 45 generates a driving signal for instructing the light source unit 10 on the driving timing and the amount of light for driving the light source (e.g., respective light sources corresponding to RGB), and supplies the generated driving signal to the light source unit 10.

The description of the process (i.e., the process by the reflection unit 44 and the process by the light source control unit 45) after the completion of the calibration (i.e., after calculating the coordinate transformation information Ic) is merely an example. A virtual object may be displayed to be superimposed on a desired scenery position by any method adopted in existing AR products. Example of documents disclosing such a technique include JP 2015-116336 and JP 2016-525741. As shown in these documents, the display device 1 performs line-of-sight detection of the user, and performs control so that the virtual object is appropriately visually recognized.

Each component of the virtual object acquisition unit 41, the feature extraction unit 42, the coordinate transformation information generation unit 43, the reflection unit 44, and the light source control unit 45 described in FIG. 2 can be realized, for example, by the control unit 17 executing a program. In addition, the necessary program may be recorded in any non-volatile storage medium and installed as necessary to realize the respective components. In addition, at least a part of these components is not limited to being realized by a software program and may be realized by any combination of hardware, firmware, and software. At least some of these components may also be implemented using user-programmable integrated circuitry, such as FPGA (Field-Programmable Gate Array) and microcontrollers. In this case, the integrated circuit may be used to realize a program for configuring each of the above-described components. Further, at least a part of the components may be configured by an ASSP (Application Specific Standard Produce), an ASIC (Application Specific Integrated Circuit) and/or a quantum processor (quantum computer control chip). In this way, each component may be implemented by a variety of hardware. The above is true for other example embodiments to be described later. Further, each of these components may be realized by the collaboration of a plurality of computers, for example, using cloud computing technology.

### (3) Examples of Label Definition of Structural Feature Point

FIG. 3A shows a label definition example of the first structural feature point group of the training field that is a tennis court, and FIG. 3B shows a label definition example of the first structural feature point group and the second structural feature point group of the display target field that is a tennis court. In FIG. 3A and FIG. 3B, the positions of the structural feature points are circled and provided with the corresponding label numbers. In this example, although the training field and the display target field are fields having the same structural feature points, the feature extractor is trained to extract only a part of these structural feature points (here, only the structural feature points of a singles court).

As shown in FIG. 3A, the structural feature points of the first structural feature point group to be extracted by the trained feature extractor are ten feature points associated with the single court, and these structural feature points are, in order from a corner, labeled with a serial number from “0” to “9”. On the other hand, as shown in FIG. 3B, the second structural feature point group includes four structural feature points (here, four corners of the doubles court) that are not included in the first structural feature point group, and the label numbers “o0” to “o3” are assigned to the four structural feature points in order from the corners.

FIG. 4A shows a label definition example of the first structural feature point group of the training field that is a pool, and FIG. 4B shows a label definition example of the first structural feature point group and the second structural feature point group of the display target field that is a pool. In FIG. 4A and FIG. 4B, the positions of the structural feature points are circled and provided with the corresponding label numbers. When the field is a pool, the centers of floats with a particular color provided at predetermined distance intervals in ropes for separating the courses are selected as structural feature points. In this example, the training field is a pool equipped with eight lanes, while the display target field is a pool equipped with ten lanes. Therefore, the display target field has more structural feature points because the number of the lanes and the number of floats are larger than those of the training field. Then, there are 25 structural feature points of the first structural feature point group, and these structural feature points are given serial numbers from “0” to “24” as labels. On the other hand, the second structural feature point group includes six structural feature points corresponding to floats of lanes at both ends which were not included in the first structural feature point group, and the label numbers “o0” to “o5” are assigned to the six structural feature points, respectively.

Here, the effect of defining the structural feature points of the second structural feature point group will be described.

Each structural feature point of the second structural feature point group is generally arranged around the first structural feature point group, and may be erroneously extracted by the feature extractor as a structural feature point of the first structural feature point group due to the similarity of the structures of the training field and the display target field. In this case, some structural feature points of the first structural feature point group which should be extracted by the feature extractor become undetected, and the number of structural feature points used for estimating the position of the display target field in the device coordinate system decreases. As a result, the estimation accuracy decreases and estimation time increases. This tendency is remarkable, for example, when an upper limit (m described above) of the number of structural feature points to be estimated is set, and the structural feature points of the first structural feature point group existing around the incorrectly extracted positions tend to be undetected. On the other hand, re-learning the feature extractor for all display target fields comes with a large data cost, and it is not practical to correspond to various specifications in the training phase which requires a huge amount of data.

Taking the above into consideration, in the present example embodiment, the display device 1 corrects the candidate label outputted by the feature extractor using the second structural data related to the other structural feature points of the display target field which have not been defined as the first structural feature point group. Thus, the display device 1 can accurately estimate the position of the display target field in the device coordinate system by using the structural feature points of the second structural feature point group extracted by the feature extractor by mistake as the structural feature points of the first structural feature point group.

In the examples shown in FIG. 3A, FIG. 3B, FIG. 4A, and FIG. 4B, there are provided such label definitions that the label name and the corresponding position of the structural feature point are uniquely determined, but the example of the label definition is not limited thereto. For example, there may be provided such label definitions that a label is assigned to structural feature points in symmetrical positions. Thereafter, a label definition that uniquely determines the label name and the corresponding position of the structural feature point is referred to as “first label definition”, and a label definition that assigns the same label to plural structural feature points that are symmetrical is referred to as “second label definition”.

FIG. 5A illustrates the correspondence between the structural feature points and labels when labels determined according to the second label definition are assigned to respective structural feature points of the display target field shown in FIG. 3B. In this instance, a label is assigned in common to symmetrical structural feature points, so that every label from 0 to 4 and from o0 to o1 is assigned to two structural feature points in symmetrical positions. FIG. 5B is a diagram illustrating a correspondence between structural feature points and labels when labels determined according to the second label definition are assigned to structural feature points of the display target field shown in FIG. 4B. In this instance, a label is assigned in common to symmetrical structural feature points, so that every label from 0 to 12 and from o0 to o2 is assigned to two structural feature points in symmetrical positions.

### (4) Process by Field Estimation Unit

### (4-1) Outline

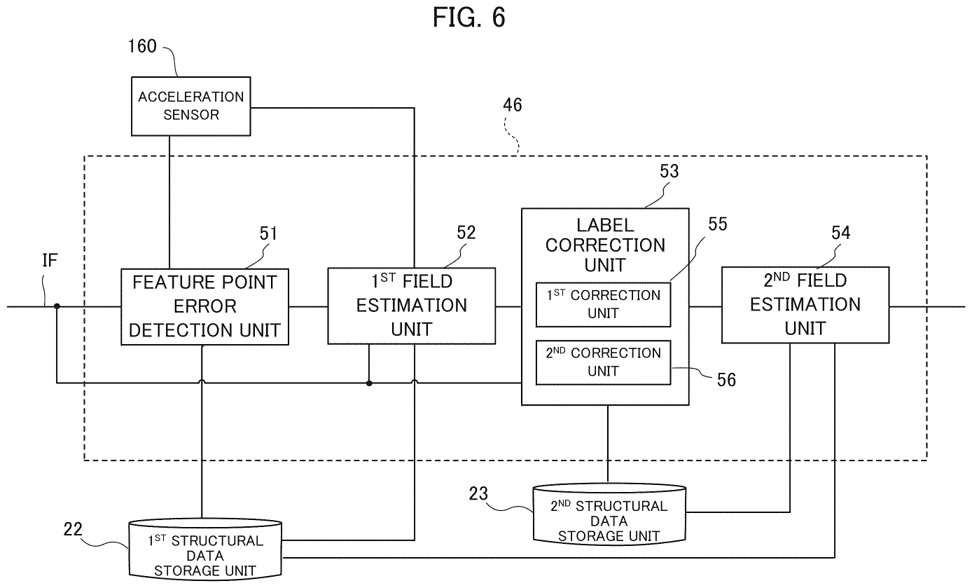

FIG. 6 is a functional block diagram of the field estimation unit 46 that shows an outline of the process by the field estimation unit 46. As shown in FIG. 6, the field estimation unit 46 functionally includes a feature point error detection unit 51, a first field estimation unit 52, a label correction unit 53, and a second field estimation unit 54. Although not explicitly shown in FIG. 6, each component of the field estimation unit 46 performs each process with reference to the position/posture change amount Ap stored in the sensor data storage unit 20 and the parameters (internal parameters, including the size of the captured image Im) of the camera stored in the parameter storage unit 21.

Based on the feature point information IF supplied from the feature extraction unit 42 and the first structural data stored in the first structural data storage unit 22, the feature point error detection unit 51 detects an extracted feature position (also referred to as an “extracted error feature position”) representing an incorrect extraction result of the structural feature point (specifically, the structural feature point of the first structural feature point group). In this case, in some embodiments, the feature point error detection unit 51 may perform a process of aligning the axis in the vertical direction of the field coordinate system parallel to the axis in the vertical direction of the device coordinate system, based on the output signal from the acceleration sensor 160 included in the position/posture detection sensor 16. Then, the feature point error detection unit 51 supplies the detection result of the extracted error feature position(s) to the first field estimation unit 52 and the label correction unit 53.

The first field estimation unit 52 estimates the position of the display target field in the device coordinate system, based on the feature point information IF, the detection result of the extracted error feature positions by the feature point error detection unit 51, and the first structural data stored in the first structural data storage unit 22. In this case, in some embodiments, the first field estimation unit 52 may perform, based on the output signal from the acceleration sensor 160, a process of aligning the axis in the vertical direction of the field coordinate system parallel to the axis in the vertical direction of the device coordinate system.

It is noted that the estimated position of the display target field in the device coordinate system calculated by the first field estimation unit 52 is a tentatively-estimated position used by the label correction unit 53, and the final estimated position of the display target field is determined by the second field estimation unit 54. In other words, the first field estimation unit 52 generates information (also referred to as “first field estimation information”) indicating the first estimation result of the display target field in the device coordinate system, and the second field estimation unit 54 generates information (also referred to as “second field estimation information”) indicating the second estimation result of the display target field in the device coordinate system. The first field estimation unit 52 supplies the first field estimation information indicating the estimated position of the display target field to the label correction unit 53.

The label correction unit 53 corrects a candidate label of the feature point information IF, based on the first field estimation information supplied from the first field estimation unit 52, the feature point information IF, and the second structural data stored in the second structural data storage unit 23. Here, the label correction unit 53 functionally includes a first correction unit 55 and a second correction unit 56.

The first correction unit 55 detects an extracted error feature position (also referred to as “extracted first label error feature position”) that becomes the position of the correct structural feature point by changing the candidate label into another candidate label representing a structural feature point of the first structural feature point group, and corrects the candidate label of the extracted first label error feature position. The second correction unit 56 detects an extracted error feature position (also referred to as “extracted second label error feature position”) which becomes a position of a correct structural feature point by changing the candidate label into a candidate label representing a structural feature point of the second structural feature point group, and corrects the candidate label of the extracted second label error feature position. Then, the label correction unit 53 supplies the feature point information IF obtained by correcting the candidate labels of the extracted first label error feature position and the extracted second label error feature position to the second field estimation unit 54. The feature point information IF that is supplied to the second field estimation unit 54 by the label correction unit 53 is an example of the “corrected feature point information”.

The process by the first correction unit 55 and the process by the second correction unit 56 may be performed in parallel, or the process by the second correction unit 56 may be performed after the process by the first correction unit 55, or the process by the first correction unit 55 may be performed after the process by the second correction unit 56. Further, in some embodiments, the first correction unit 55 and the second correction unit 56 performs process in collaboration with each other, and each of them finally determines the correction of the candidate label in consideration of the detection result of extracted error feature positions obtained by the other. In this case, the first correction unit 55 and the second correction unit 56 may transmit and receive processing results mutually so as to reflect the correction by the other, upon detecting the same extracted error feature position as the extracted first label error feature position and the extracted second label error feature position.

The second field estimation unit 54 generates the second field estimation information, which represents the estimated position of the display target field, based on the feature point information IF in which the correction by the label correction unit 53 is reflected, the first structural data stored in the first structural data storage unit 22, and the second structural data stored in the second structural data storage unit 23. Here, the processing results of the feature point error detection unit 51, the first field estimation unit 52, and the label correction unit 53 are reflected in the estimated position of the display target field calculated by the second field estimation unit 54 and the estimated position of the display target field becomes the estimated position of the display target field that is finally outputted by the field estimation unit 46. Then, the coordinate transformation information Ic is generated based on the second field estimation information outputted by the second field estimation unit 54.

### (4-2) Feature Point Error Detection Unit

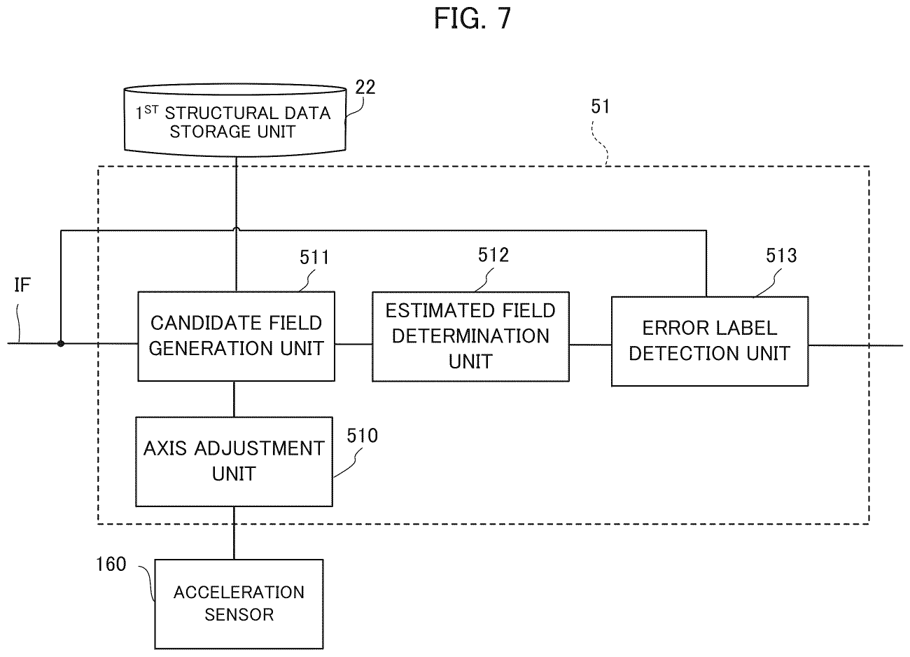

FIG. 7 is an example of a functional block of the feature point error detection unit 51. The feature point error detection unit 51 functionally includes an axis adjustment unit 510, a candidate field generation unit 511, an estimated field determination unit 512, and an error label detection unit 513.

The axis adjustment unit 510 recognizes the vertical direction in the device coordinate system based on the output signal from the acceleration sensor 160. Then, based on the recognized vertical direction, the axis adjustment unit 510 adjusts the axes in the height direction of the device coordinate system and the field coordinate system to be parallel with each other.

The candidate field generation unit 511 performs, several times, the process of generating a candidate (also referred to as “candidate field”) for the display target field in the device coordinate system using two of the extracted feature positions indicated by the feature point information IF. In this case, the candidate field generation unit 511 may generate n candidate fields from n pairs of the extracted feature positions (n is an integer of 3 or more) which are randomly selected by n times. Instead, it may generate candidate fields using all possible pairs of the extracted feature positions. The candidate field generation unit 511 identifies, as a candidate field, for example, estimated positions of the structural feature points in the device coordinate system for respective labels and the estimated plane of the display target field in the device coordinate system.

Here, a case where the candidate field is generated from all possible pairs of the extracted feature positions will be supplemented. If the first label definition which uniquely determines the label name and the position of the structural feature point is adopted and the number of extracted feature positions is N1, the candidate field generation unit 511 generates _{N1}C₂ candidate fields from _{N1}C₂ pairs of extracted feature positions. On the other hand, if the label definition in which the label name and the position of the structural feature point are not uniquely determined is adopted, multiple field estimations are required from one pair. For example, in the second label definition example (i.e., a label definition in which point-symmetric labels are identical), the candidate field generation unit 511 generates “_{N1}C₂ times 2” candidate fields as a whole. Generally, in a label definition example in which one label is assigned to “M” feature point positions (M is an integer of 3 or more), the minimum number of estimated candidate fields given N1 structural feature points varies depending on the symmetry of the label definition. Specifically, if the efficiency of the process is not considered, the minimum number of the estimated candidate fields is “_{N1}C₂ times M times M”.

From a plurality of candidate fields, the estimated field determination unit 512 determines a display target field (also referred to as “estimated field”) in the device coordinate system that is finally outputted as an estimation result. In this case, the estimated field determination unit 512 applies a clustering method to the candidate fields and determines the estimated fields from the candidate fields belonging to the main cluster having the largest number of the candidate fields as its members. In other words, the estimated field determination unit 512 determines the estimated positions of the structural feature points of respective labels of the display target field in the device coordinate system (and the estimated plane of the display target field).

The error label detection unit 513 determines the extracted error feature position(s) on the basis of the estimated field determined by the estimated field determination unit 512. In this case, first, for example, based on the photographing position in the device coordinate system identified based on the position/posture change amount Ap and the parameters of the camera 15 (including the internal parameters), the error label detection unit 513 recognizes points obtained by projecting extracted feature positions onto the estimated field as extracted feature positions in the device coordinate system, respectively. Then, for each label of the first structural feature point group, the error label detection unit 513 compares the position, in the estimated field, of the structural feature point of the first structural feature point group with the extracted feature position in the device coordinate system, and then determines an extracted error feature position to be such an extracted feature position which is equal to or more than a predetermined distance from the position in the estimated field. For example, the predetermined distance described above is a predetermined fitted value stored in the storage unit 14 or the like. If the number of the structural feature points that are determined not to be extracted error feature positions becomes equal to or less than a predetermined threshold value (e.g., five), the field estimation unit 46 ends the estimation and determines that the estimation of the display target field has failed. In this instance, the field estimation unit 46 performs a field estimation process based on a newly acquired captured image Im.

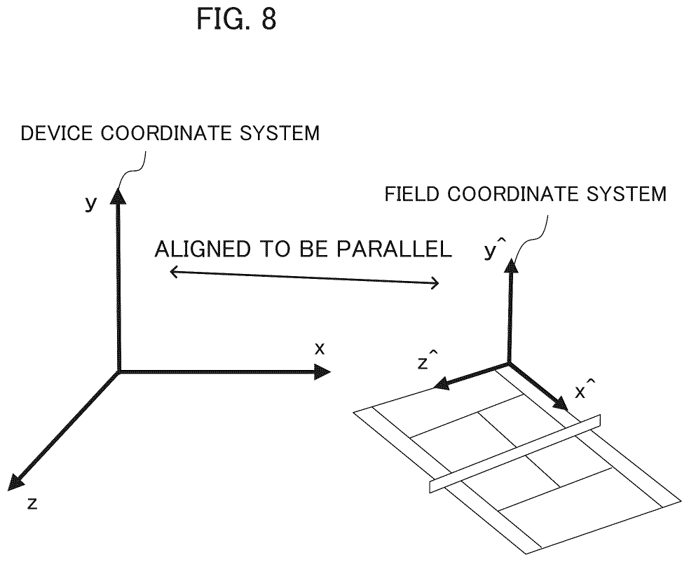

Next, a description will be specifically given of the process by the axis adjustment unit 510 with reference to FIG. 8.

FIG. 8 shows the positional relation between the device coordinate system and the field coordinate system after adjustment such that the axes in the height direction of the device coordinate system and the field coordinate system are parallel. Here, the display target field is a tennis court, and axes of the field coordinate system are provided in the longitudinal and lateral directions of the tennis court and the vertical direction perpendicular to them, respectively. Hereafter, the three axes of the device coordinate system are assumed to be the x-axis, the y-axis, and the z-axis, and the three axes of the field coordinate system are assumed to be the x\hat{ }-axis, the y\hat{ }-axis, and the z\hat{ }-axis.

In this case, based on the output signal from the acceleration sensor 160, the axis adjustment unit 510 moves at least one of the device coordinate system or the field coordinate system so that the y-axis in the device coordinate system is parallel to the y\hat{ }-axis in the field coordinate system. For example, if the y\hat{ }-axis of the field coordinate system is already parallel to the vertical direction, the axis adjustment unit 510 rotates the device coordinate system such that the y-axis of the device coordinate system is parallel to the vertical direction. In another example, if the y\hat{ }-axis of the field coordinate system is not parallel to the vertical direction, the axis adjustment unit 510 rotates both of the device coordinate system and the field coordinate system by appropriate angles, respectively, so that the y-axis of the device coordinate system and the y\hat{ }-axis of the field coordinate system are parallel to the vertical direction.

It is noted that the axis adjustment unit 510 is not an essential element in the feature point error detection unit 51. For example, instead of the feature point error detection unit 51 equipped with the axis adjustment unit 510, the candidate field generation unit 511 may generate each candidate field from three (or four or more) extracted feature positions.

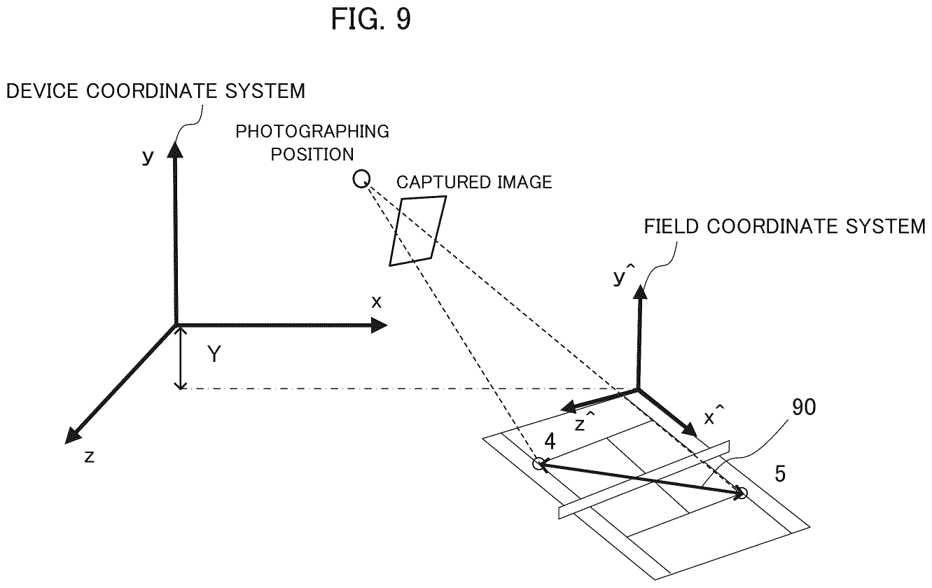

Next, a process of generating the candidate fields by the candidate field generation unit 511 will be specifically described with reference to FIG. 9.

FIG. 9 illustrates the device coordinate system and the field coordinate system with an indication of the photographing position of the camera 15, the captured image Im, and the display target field. Here, the y-axis of the device coordinate system and the y\hat{ }-axis of the field coordinate system are adjusted to be parallel, and these axes are shifted by an offset “Y”. Then, in this case, the candidate field generation unit 511 can determine a candidate field by calculating, from arbitrary two extracted feature positions, the offset Y and an angle (or an angle formed by the z-axis and the z\hat{ }-axis) formed by the x-axis and the x\hat{ }-axis.

Here, the process of determining the candidate field from any two extracted feature positions will be supplementally described with continued reference to FIG. 9.

In FIG. 9, the candidate field generation unit 511 generates the candidate field from two extracted feature positions with the label number 4 and the label number 5 based on the first label definition example illustrated in FIG. 3A. The distance (see arrow 90) between the two extracted feature positions with the label number 4 and the label number 5 can be identified by referring to the first structural data. Then, the candidate field generation unit 511 determines the candidate field, based on the photographing position of the camera 15 in the device coordinate system (including the photographing direction), the parameters of the camera 15, the two extracted feature positions in the captured image Im with the label number 4 and the label number 5, and the distance indicated by the arrow 90. It is noted that the photographing position (including the photographing direction) of the camera 15 in the device coordinate system is identified based on the position/posture change amount Ap.

Although the candidate field generation unit 511 needs to perform the process for determining a candidate field from a pair of the extracted feature positions a plurality of times, these processes can be computed in parallel by matrix treatment. Therefore, the candidate field generation unit 511 can calculate the candidate fields using plural pairs of the generated extracted feature positions by parallel processing.

Next, a clustering process performed by the estimated field determination unit 512 will be supplementally described.

The estimated field determination unit 512 applies an arbitrary clustering method to the candidate fields to generates clusters thereof. Such clustering methods include, but are not limited to, the single-link method, the perfect-link method, the group averaging method, Ward method, the centroid method, the weighted method, and the median method. In this case, for example, based on a four-dimensional coordinate value (vector) which includes the three-dimensional center-of-gravity coordinate value of each candidate field in the device coordinate system and the angle representing the orientation (longitudinal direction or lateral direction in the case of a tennis court) on the x-z plane, the estimated field determination unit 512 conducts the above-described clustering. As the above-described “three-dimensional center-of-gravity coordinate value of each candidate field in the device coordinate system”, for example, the coordinate value, in the device coordinate system, of the center of gravity of the estimated positions of the structural feature points for all labels constituting the candidate field is calculated. In the case where the axis adjustment based on the vertical direction is not performed, a six-dimensional coordinate value which includes the three-dimensional center-of-gravity coordinate value of each candidate field in the device coordinate system and the Euler angles (yaw, pitch, roll) is used, instead of the above-described four-dimensional coordinate value.

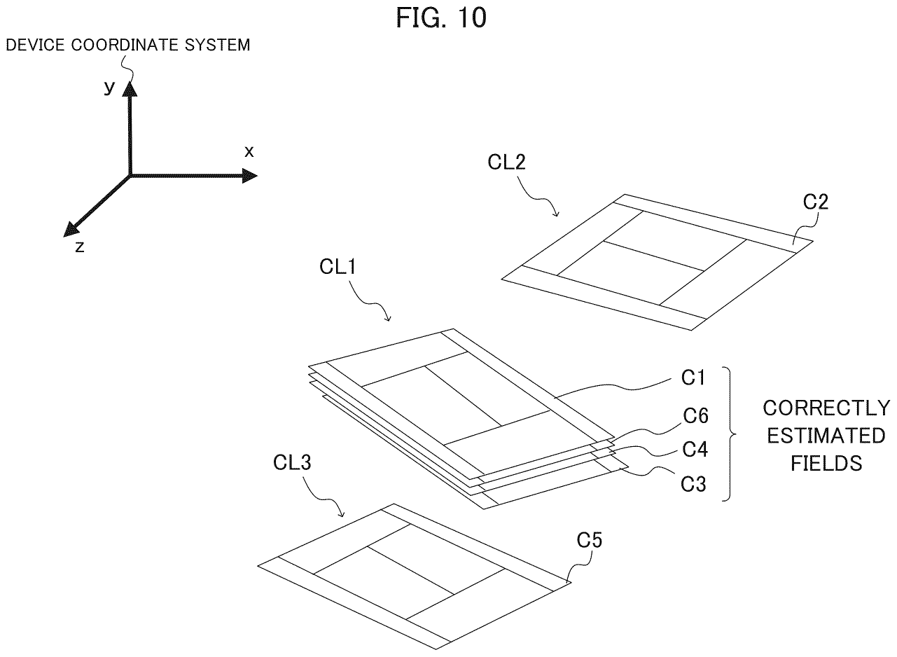

FIG. 10 illustrates a device-coordinate system with an indication of the clustering result of the generated six candidate fields “C1” to “C6”. In this case, the estimated field determination unit 512 classifies the candidate fields into the first cluster CL1, the second cluster CL2, and the third cluster CL3 by using an arbitrary clustering method. Here, the first cluster CL1 is the unit 5 and includes four candidate fields C1, C3, C4, C6. On the other hand, the second cluster CL2 includes the candidate field C2 and the third cluster CL3 includes the candidate field C5.

In this case, the estimated field determination unit 512 determines that the candidate field belonging to the first cluster CL1 which is the main cluster is the correct estimation result of the displayed target field, and determines the estimated field based on the candidate fields C1, C3, C4, and C6. For example, the estimated field determination unit 512 calculates the center of gravity (mean vector) of the above-described four-dimensional coordinate values of the respective candidate fields belonging to the main cluster, and selects the candidate field corresponding to the four-dimensional coordinate value closest to the center of gravity as the estimated field. In another example, the estimated field determination unit 512 may determine the estimated field obtained by integrating the candidate fields belonging to the main cluster based on: a statistical process such as the average of the candidate fields belonging to the main cluster (including the weighted average according to the distance from the center of gravity described above); or an analysis process such as the least squares method using the positional relation (i.e., the model of the display target field) of the structural feature points identified by the first structural data. In this case, for example, in some embodiments, the estimated field determination unit 512 sets a model or a constraint condition representing the positional relation (distance) between structural feature points of the first structural feature point group indicated by the first structural data, and then determines the estimated field by performing optimization (including analysis by a least squares method or the like) so as to minimize the sum of errors, for respective labels, between the structural feature points of the estimated field and the point group of the extracted feature positions of the candidate fields belonging to the main cluster. In yet another example, the estimated field determination unit 512 may determine the estimated field to be a candidate field randomly selected from the candidate fields belonging to the main cluster. Thus, the estimated field determination unit 512 determines the estimated field based on the integration or selection of the candidate fields belonging to the main cluster.

### (4-3) First Field Estimation Unit

Next, a description will be given of the process by the first field estimation unit 52.

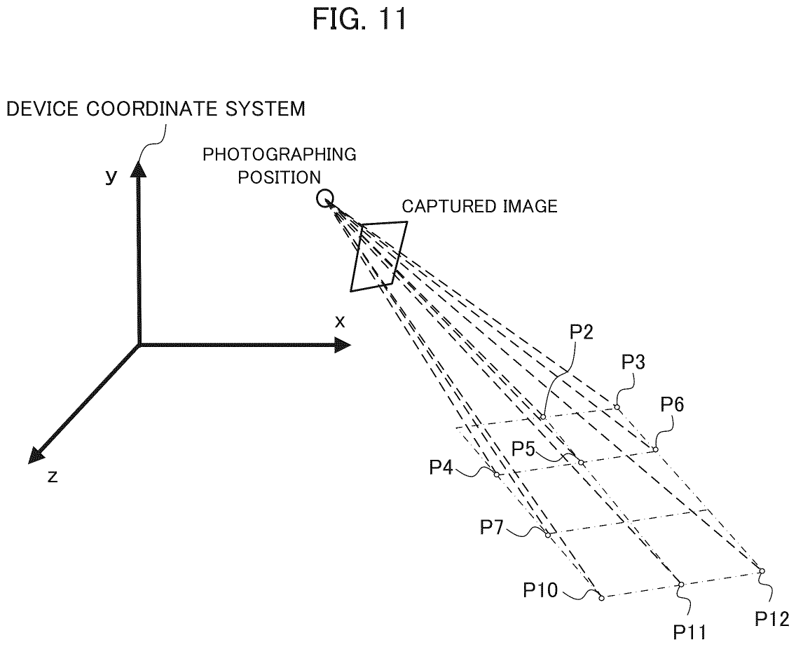

FIG. 11 illustrates the device coordinate system with an indication of estimated position of the display target field obtained through the optimization process based on the extracted feature positions other than extracted error feature positions. Here, as the structural feature points of the first structural feature point group, the vertices (total of 12 vertices) of respective grids into which the display target field is divided is provided in the the display target field. The first field estimation unit 52 estimates the display target field based on the nine extracted feature positions “P2” to “P7” and “P10” to “P12” excluding the three extracted error feature positions. In this instance, the first field estimation unit 52 identifies the extracted feature positions P2 to P7, P10 to P12 (a broken line shown in FIG. 11) projected onto the device coordinate system, based on the parameters of the camera 15 (including the internal parameters) and the photographing position (including the photographing direction) in the device coordinate system identified based on the position/posture change amount Ap. Then, the candidate field generation unit 511 identifies the relative positional relation (model of the display target field) representing the distance or the like among the structural feature points of the first structural feature point group by referring to the first structural data, and determines the extracted feature positions P2 to P7, P10 to P12 and the entire estimated field in the device coordinate system so that the positional relation among the specified structural feature points are maintained.

In this way, on such an assumption that there is no incorrect candidate label for the extracted feature positions to be used and that the distortion caused by the internal parameters of the camera 15 and the like is adjusted, the first field estimation unit 52 estimates the display target field in the device coordinate system, on the basis of the first structural data and at least some sets of the extracted feature position and the candidate label indicated by the feature point information IF.

If the structural feature points of the display target field are displaced in an anisotropic way (biased in a certain direction), the first field estimation unit 52 performs optimization in consideration of the anisotropic displacement to determine the estimated position of the display target field. Examples of fields where the structural feature points are displaced in an anisotropic way (biased in a direction) include a pool (for competition) shown in FIG. 4A and FIG. 4B. The display target field having such properties can be regarded as a quasi-rigid body having properties conforming to a rigid body.

In this case, first, for each label, the first field estimation unit 52 calculates the distances (i.e., errors) in the x-axis direction and the distances in the z-axis direction between the estimated position of the target structural feature point of estimation in the first structural feature point group and the extracted feature position in the device coordinate system, and then calculates the sum of the distances in the x-axis direction and the sum of the distances in the z-axis direction. Then, the first field estimation unit 52 sets an evaluation function that is a sum of the sum of the distances in the x-axis direction and the sum of the distances in the z-axis direction multiplied by respectively different weighting coefficients (the coefficient “ax” corresponding to the x-axis, the coefficient “ay” corresponding to the y-axis). Then, the first field estimation unit 52 calculates the solution of the above-described estimated position to minimize the above-described evaluation function, using a constraint condition that is the relative positional relation among structural feature points based on the first structural data. For example, the above-described constraint condition may be regarded as a model of the display target field and the above-described calculation may be performed by a weighted least squares method.

On the other hand, the first field estimation unit 52 performs isotropic optimization when the structural feature points of the field are not displaced in an anisotropic way. In this case, for each label, the first field estimation unit 52 calculates the distance (i.e., error) between the estimated position of the structural feature point in the first structural feature point group and the extracted feature position in the device coordinate system, and then calculates the solution of the above-described estimated position that minimizes an evaluation function by using the sum of the distances for respective labels as the evaluation function. In this case, the first field estimation unit 52 performs calculation of the above-described solution using a constraint condition that is the relative positional relation among the structural feature points based on the first structural data stored in the first structural data storage unit 22 is satisfied. For example, the above-described constraint condition may be regarded as a model of the display target field and the above-described calculation may be performed by the least squares method.

The optimization method described above is an example, and it may be performed isotropic or anisotropic optimization for each coordinate axis based on an arbitrary evaluation function.

The first field estimation unit 52 supplies the estimation result of the display target field to the label correction unit 53 as the first field estimation information. Here, the first field estimation information is information that indicates, for example, a set of estimated positions in the device coordinate system and labels of the structural feature points of the first structural feature point group and the estimated plane (also referred to as “estimated field plane”) of the display target field in the device coordinate system identified from the estimated positions of these structural feature points, respectively.

The process of adjusting the y-axis of the device coordinate system so as to be parallel to the vertical direction (that is, the normal direction of the field) is not an essential process, and the first field estimation unit 52 may perform the estimation of the display target field by the above-described optimization without performing this process. In this case, the first field estimation unit 52 performs the above-described optimization based on the distance in the three-dimensional space between the estimated position of the structural feature point in the first structural feature point group and the extracted feature position in the device coordinate system.

### (4-4) Label Correction Unit

First, the process by the first correction unit 55 will be specifically described. The first correction unit 55 detects the extracted first label error feature position, on the basis of the first field estimation information supplied from the first field estimation unit 52 and the feature point information IF, and corrects the candidate label of the detected extracted first label error feature position. In the following, it is assumed that the distortion due to the internal parameters of the camera 15 or the like has been adjusted.

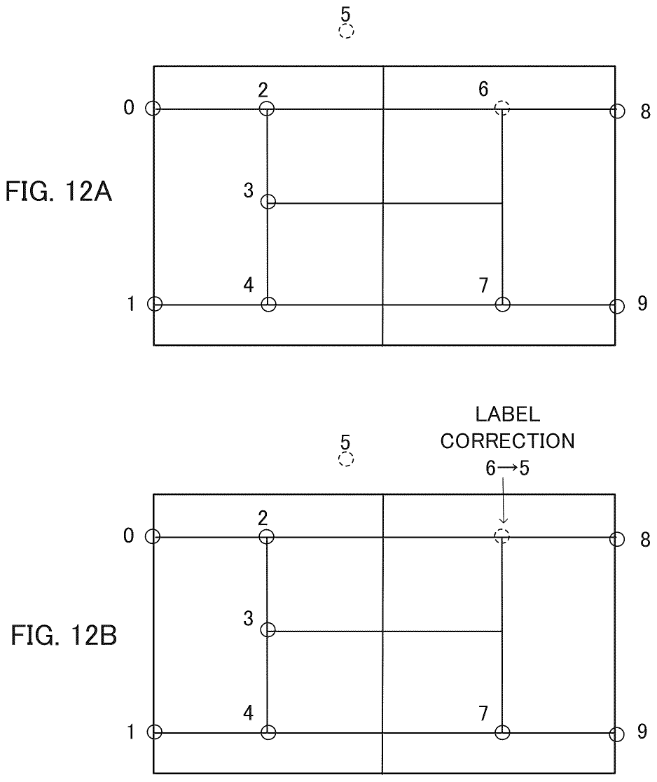

FIG. 12A illustrates the estimated field plane with an indication of the extracted feature positions associated with the candidate labels in the case where the display target field is a tennis court. It is herein assumed that, by applying the process in the first field estimation unit 52 described with reference to FIG. 11, each extracted feature position is converted based on the photographing position and parameters of the camera 15 into a position in the device coordinate system. In FIG. 12A, as an example, labels based on the first label definition example regarding the tennis court shown in FIG. 3A are assigned to respective structural feature points of the first structural feature point group. In FIG. 12A, extracted error feature positions are indicated by dotted circles, and the other extracted feature positions are indicated by solid circles, respectively. Here, the extracted error feature positions are extracted feature positions corresponding to the candidate label 5 and the candidate label 6.

FIG. 12B illustrates the estimated field plane with an indication of sets of an extracted feature position and its candidate label after the candidate label correction by the first correction unit 55.

In this case, the first correction unit 55 compares the sets of the structural feature point of the first structural feature point group and the label identified based on the first field estimation information with the sets of the extracted feature position and the candidate label indicated by the feature point information IF. In this instance, as respective extracted feature positions in the device coordinate system, the first correction unit 55 calculates projected positions (e.g., extracted feature positions P2 to P7, P10 to P12 in FIG. 11) of respective extracted feature positions indicated by the feature point information IF onto the estimated field plane indicated by the first field estimation information. In this case, the first correction unit 55 calculates the respective extracted feature positions in the device coordinate system in consideration of the distortion caused by the internal parameters of the camera 15 or the like.

Then, for each of the labels 0 to 4 and 7 to 9, since the distance between the position of the structural feature point based on the first field estimation information and the extracted feature position in the device coordinate system corresponding to the same label is within a predetermined threshold value, the first correction unit 55 determines that these extracted feature positions are consistent with the first field estimation information (i.e., coincide with the positions of the structural feature points indicated by the first field estimation information). The predetermined threshold value described above is, for example, a distance (Euclidean distance) that can be regarded as the same position, and its fitted value is stored in advance in the storage unit 14 or the like.

On the other hand, for each of the label 5 and the label 6, the first correction unit 55 determines that the distance between the position of the structural feature point based on the first field estimation information and the extracted feature position in the device coordinate system corresponding to the same label is longer than the predetermined threshold value. Therefore, in this case, the first correction unit 55 determines that these extracted feature positions are not consistent with the first field estimation information.

In some embodiments, the first correction unit 55 may determine whether or not each extracted feature position is consistent with the first field estimation information, on the basis of the detection result of the extracted error feature position by the feature point error detection unit 51. In this case, the first correction unit 55 determines that the extracted error feature positions detected by the feature point error detection unit 51 are not consistent with the first field estimation information, and determines that the extracted feature positions other than the extracted error feature positions detected by the feature point error detection unit 51 are consistent with the first field estimation information.

Next, among the extracted feature positions (the extracted feature positions with the candidate labels 5 and 6) that are not consistent with the first field estimation information, the first correction unit 55 detects, as an extracted first label error feature position, an extracted feature position that becomes consistent with the first field estimation information by correcting the candidate label to another label of the first structural feature point group. In this case, using the Euclidean distance, the first correction unit 55 detects, as an extracted first label error feature position, any extracted feature position that is not consistent with the first field estimation information and from which the distance to any one of the structural feature points of the first structural feature point group is equal to or less than a predetermined threshold value. The predetermined threshold value described above may be the same as or different from the threshold value used in determining whether or not each extracted feature position is consistent with the first field estimation information.

In the example shown in FIG. 12B, the distance between the extracted feature position of the candidate label 5 in the device coordinate system and the position of any structural feature point of the first structural feature point group based on the first field estimation information is longer than the predetermined threshold value. Thus, the first correction unit 55 determines that the extracted feature position with the candidate label 5 is not an extracted first label error feature position.

On the other hand, since the distance between the extracted feature position in the device coordinate system associated with the candidate label 6 and the position of the structural feature point with the label 5 based on the first field estimation information is less than the predetermined threshold value, the first correction unit 55 detects the extracted feature position associated with the candidate label 6 as the extracted first label error feature position. Namely, in this case, the first correction unit 55 determines that the error can be corrected (i.e., consistent with the first field estimation information) by correcting the candidate label to 5. Therefore, in this case, the first correction unit 55 generates the feature point information IF in which the candidate label of the extracted feature position associated with the candidate label 6 is corrected to be 5, as shown in FIG. 12B. Thus, the first correction unit 55 can suitably correct the error of the feature point information IF.

As such, the first correction unit 55 corrects candidate labels of extracted first label error feature positions among the extracted feature positions that are not consistent with the first field estimation information. Thus, the first correction unit 55 can suitably correct the error of the candidate label of the extracted feature position corresponding to the structural feature point of the first structural feature point group.

Next, the process by the second correction unit 56 will be specifically described. On the basis of the first field estimation information, the feature point information IF, and the second structural data, the second correction unit 56 detects an extracted second label error feature position and corrects the candidate label associated with the detected extracted second label error feature position. In the following, it is assumed that the distortion due to the internal parameters of the camera 15 has been adjusted.

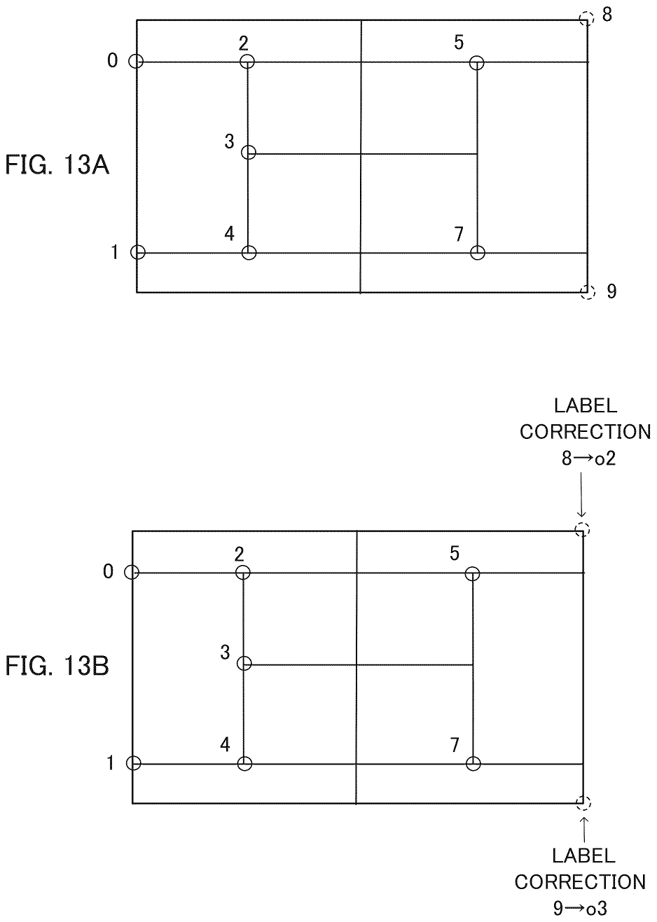

FIG. 13A illustrates the estimated field plane based on the first field estimation information with an indication of the extracted feature positions associated with the candidate labels in the case where the display target field is a tennis court. It is herein assumed that, by applying the process in the first field estimation unit 52 described with reference to FIG. 11 or the like, each extracted feature position is converted based on the photographing position and parameters of the camera 15 into a position in the device coordinate system. Further, as an example, it is assumed that the labels based on the first label definition example of the tennis court shown in FIG. 3B are assigned to respective structural feature points of the first structural feature point group and the second structural feature point group. In FIG. 13A, the extracted error feature positions are indicated by dotted circles, and the other extracted feature positions are indicated by solid circles. Here, the extracted error feature positions are extracted feature positions associated with the candidate label 8 and the candidate label 9.

FIG. 13B illustrates the estimated field plane based on the first field estimation information with an indication of sets of an extracted feature position and its candidate label after the candidate label correction by a second correction unit 56. In this case, the second correction unit 56 compares the sets of the structural feature point of the second structural feature point group and the label thereof identified by the second structural data with the sets of the extracted feature position and the candidate label thereof indicated by the feature point information IF. In this instance, the second correction unit 56 calculates, as each extracted feature position in the device coordinate system, the projected position (e.g., extracted feature positions P2 to P7, P10 to P12 in FIG. 11) of each extracted feature position indicated by the feature point information IF onto the estimated field plane indicated by the first field estimation information. In this case, the second correction unit 56 calculates each extracted feature position in the device coordinate system in consideration of the distortion caused by the internal parameters of the camera 15 or the like.

Then, the second correction unit 56 identifies an extracted feature position that is not consistent with the first field estimation information (that is, does not match any structural feature point of the first structural feature point group). The second correction unit 56 herein determines that each of extracted feature positions associated with the candidate label 8 and the candidate label 9 is at least a predetermined distance away from any structural feature point of the first structural feature point group and that they are not consistent with the first field estimation information. The second correction unit 56 may identify, in the same way as the first correction unit 55 does, an extracted feature position that is not consistent with the first field estimation information, or may identify, on the basis of the information of the processing result received from the first correction unit 55, an extracted feature position that is not consistent with the first field estimation information.

Next, among the extracted feature positions (the extracted feature positions associated with the candidate labels 8 and 9 in this case) that are not consistent with the first field estimation information, the second correction unit 56 detects, as the extracted second label error feature position, an extracted feature position corresponding to a structural feature point of the second structural feature point group.

In this case, as an extracted second label error feature position, the second correction unit 56 detects, using the Euclidean distance, an extracted feature position which is not consistent with the first field estimation information and from which the distance to any one of the structural feature points of the second structural feature point group is equal to or less than a predetermined threshold value. The predetermined threshold value described above may be the same as or different from the threshold value used in determining whether or not each extracted feature position is consistent with the first field estimation information. Here, based on the first field estimation information and the second structural data, the second correction unit 56 identifies the positions of the structural feature points of the second structural feature point group in the device coordinate system. In this case, based on the second structural data (and the first structural data), the second correction unit 56 identifies the relative positional relation between the structural feature points of the first structural feature point group and the structural feature points of the second structural feature point group.

In the example shown in FIG. 13B, since the distance between the extracted feature position in the device coordinate system associated with the candidate label 8 and the structural feature point of the second structural feature point group associated with the label o2 is equal to or less than the predetermined threshold value, the second correction unit 56 detects the extracted feature position associated with the candidate label 8 as an extracted second label error feature position. Similarly, since the distance between the extracted feature position in the device coordinate system associated with the candidate label 9 and the structural feature point of the second structural feature point group associated with the label o3 is equal to or less than the predetermined threshold value, the second correction unit 56 detects the extracted feature position associated with the candidate label 9 as an extracted second label error feature position. Therefore, the second correction unit 56 generates the feature point information IF (corrected feature point information) in which the candidate labels of the extracted feature positions are corrected from the candidate label 8 to o2 and from the candidate label 9 to o3.

As such, the second correction unit 56 corrects the candidate labels of the extracted second label error feature positions, each of which is not consistent with the first field estimation information and can be corrected by changing the candidate label into a label representing a structural feature point of the second structural feature point group.

Here, a supplementary description will be given effect based on the process by the second correction unit 56.

Each structural feature point of the second structural feature point group is arranged around the first structural feature point group, and there is a possibility that the feature extractor can extract it as a structural feature point of the first structural feature point group by mistake. In this case, by correcting the candidate label to a label of the second structural feature point group by the second correction unit 56, it is possible to secure the sufficient number of structural feature points used for the position estimation of the display target field in the device coordinate system to thereby estimate the display target field with high accuracy. Further, even when the specifications are different between the training field and the display target field, it is possible to estimate the display target field with high accuracy without performing re-training of the feature extractor. For example, when the training field shown in FIG. 4A and the display target field shown in FIG. 4B are used, the feature extractor trained for a stadium with eight lanes can be used without reducing the accuracy for a stadium with ten lanes.

Even when the training field and the display target field have the same specification, the same effect can be obtained by determining a candidate position (that is, the frequently-extracted error feature position), which is erroneously extracted as a structural feature point of the first structural feature point group, to be a structural feature point of the second structural feature point group.

FIG. 14 is a diagram showing a correspondence between structural feature points and labels when a pool equipped with a long float in its center is used as a training field and a display target field. In FIG. 14, structural feature points (labels 0 to 24) of the first structural feature point group are indicated by solid circles, and structural feature points (label o1 to o14) of the second structural feature point group are indicated by dashed circles. In this example, when the structural feature points (labels 9 to 15) of the first structural feature point group is extracted from the central part of the long float, both end positions of the floats are defined as the structural feature point (labels o1 to o14) of the second structural feature point group because both end positions of the floats are easily extracted by mistake. In this way, even when the structural feature points associated with the labels o1 to o14 are erroneously extracted by the feature extractor as the structural feature points of the labels 9 to 15, the display device 1 can modify the candidate labels by the second correction unit 56 and use these feature extraction results in the field estimation. Therefore, in this case, the display device 1 can secure the sufficient number of structural feature points to be used for field estimation by correction of the candidate labels to labels corresponding to the structural feature points of the second structural feature point group, and perform the field estimation with high accuracy.

### (4-5) Second Field Estimation Unit

For example, based on the feature point information IF modified by the first correction unit 55 and the second correction unit 56, the second field estimation unit 54 performs the same process as the first field estimation unit 52 to thereby generate the second field estimation information. In generating the second field estimation information, the second field estimation unit 54 estimates the display target field based on the feature point information IF in which errors of candidate labels are appropriately corrected by the first correction unit 55 and the second correction unit 56. Thus, the second field estimation information having higher accuracy than the first field estimation information can be suitably generated. In other words, the second field estimation unit 54 can perform accurate estimation of the display target field on the basis of the feature point information IF including the information regarding the extracted feature positions that exactly correspond to the structural feature points of the first structural feature point group and the second structural feature point group.

The field estimation unit 46 may determine the success or failure of the field estimation according to the error amount or/and the number of structural feature points to be used after correction by the label correction unit 53. For example, the field estimation unit 46 aborts the field estimation and determines that the field estimation has failed if any one of the following (Case A), (Case B), and (Case C) comes up.
(Case A) a case where the total number “n” of structural feature points to be used for field estimation by the second field estimation unit 54 including structural feature points corrected by the label correction unit 53 is equal to or less than a predetermined threshold value.
(Case B) a case where the ratio (n/Np) of the total number n to the number of feature points “Np” (i.e., the number of feature points indicated by the feature point information IF) obtained by the feature extraction unit 42 is equal to or less than a predetermined threshold.
(Case C) a case where the structural feature points with corrected labels and any other labels to be used for field estimation are positioned in a straight line on the structural data (for example, labels 10, 11, 12, and 13 in FIG. 4A), in other words, a case where the field estimation is performed using only structural feature points aligned structurally in a direct line.

Then, upon determining that one of (Case A), (Case B), and (Case C) comes up and aborting the field estimation, the field estimation unit 46 performs a field estimation process based on a newly-acquired captured image Im. In some embodiments, the field estimation unit 46 stops the field estimation in the case of (Case C) to prevent the the execution of the field estimation with low accuracy. It is noted, if the field estimation is performed using only structural feature points on the same straight line structurally, the accuracy is significantly lower than that in the other cases. In some embodiments, to determine whether or not the executed field estimation result in failure, the field estimation unit 46 may determine whether or not (Case A) or (Case B) comes up after the estimation process by the second field estimation unit 54. In other words, in this case, similarly to the distance comparison with the position of the structural feature point by the label correction unit 53, the field estimation unit 46 matches the positions of the structural feature point obtained by the feature extraction unit 42 with the positions of the structural feature point after the field estimation, and then determines whether or not (Case A) or (Case B) comes up for the matched structural feature points.

### (5) Processing Flow

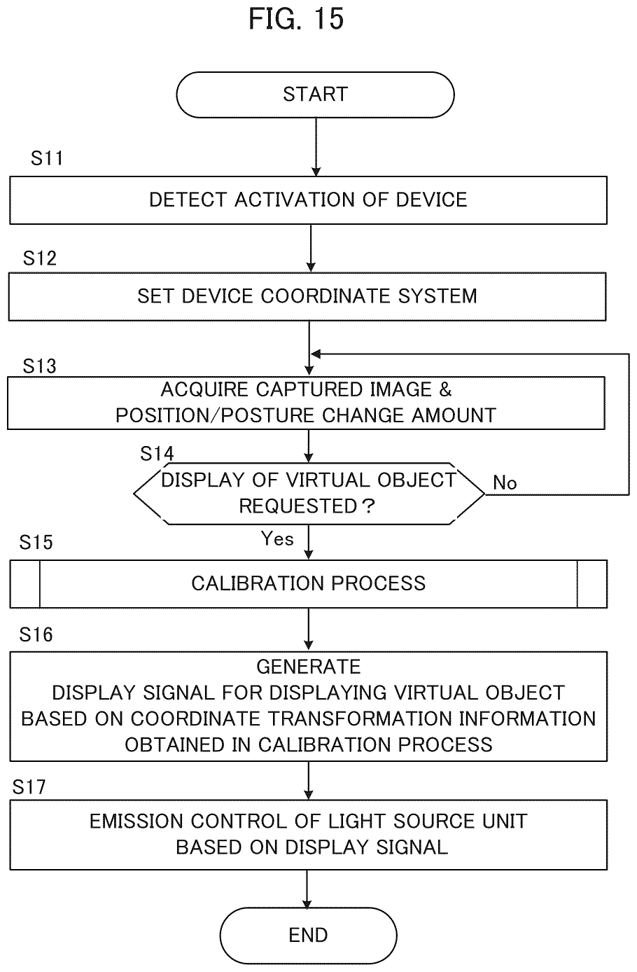

FIG. 15 is an example of a flowchart illustrating an overview of a process related to a display process of a virtual object that is executed by the control unit 17 in the first example embodiment.

First, the control unit 17 detects the activation of the display device 1 (step S11). In this instance, the control unit 17 sets a device coordinate system based on the posture and the position of the display device 1 at the time of activation of the display device 1 (step S12). Thereafter, the control unit 17 acquires the captured image Im generated by the camera 15, and acquires the position/posture change amount Ap based on the detection signal outputted by the position/posture detection sensor 16 (step S13). The control unit 17 stores a set of the captured image Im and the position/posture change amount Ap acquired at step S13 in the sensor data storage unit 20.

Then, the control unit 17 determines whether or not there is a request for displaying a virtual object (step S14). For example, upon receiving distribution information instructing the display of the virtual object from a server device (not shown) managed by a promoter, the virtual object acquisition unit 41 determines that there is a request for displaying a virtual object. Then, upon determining that there is no request for displaying the virtual object (step S14; No), the captured image Im and the position/posture change Ap are acquired at step S13.

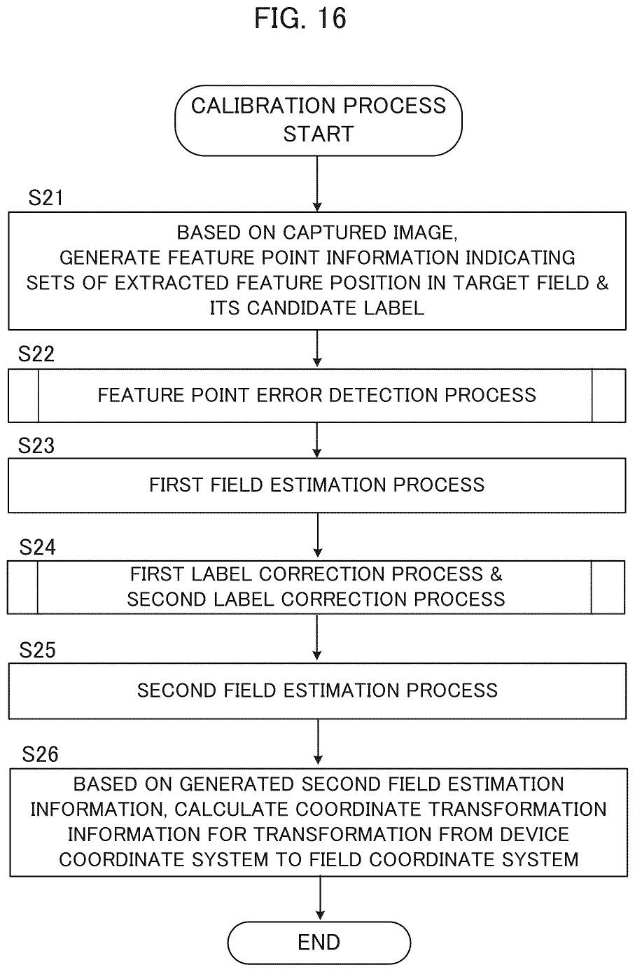

On the other hand, upon determining that there is a request for displaying a virtual object (step S14; Yes), the control unit 17 executes a calibration process (step S15). Details of the procedure of the calibration process will be described later with reference to FIG. 16.

Next, the reflection unit 44 of the control unit 17 generates the display signal Sd for displaying the virtual object at the display position designated in the display request, on the basis of the coordinate transformation information Ic obtained in the calibration process at step S15 (step S16). In this instance, in practice, in the same way as various conventional AR display products, the control unit 17 recognizes a space, which the user visually recognizes in the device coordinate system, in view of the user's gaze direction and the position/posture change amount Ap and the like, and generates display signal Sd such that the virtual object is displayed at the designated position in the space. Then, based on the display signal Sd, the light source control unit 45 of the control unit 17 performs emission control of the light source unit 10 (step S17).

The processing procedure of the flowchart shown in FIG. 15 is an example, and it is possible to apply various changes to the processing procedure.

For example, the control unit 17 executes the calibration process at step S15 every time there is a request for displaying a virtual object, but it is not limited thereto. Alternatively, the control unit 17 may perform calibration process only when a predetermined time or more has elapsed from the previous calibration process. Thus, the control unit 17 only has to perform the calibration process at least once after the activation of the display device 1.

The control unit 17 determines the device coordinate system based on the position and posture of the display device 1 at the time of activation of the display device 1, but the approach is not limited thereto. Alternatively, for example, the control unit 17 may determine the device coordinate system with reference to the position and the posture of the display device 1 when the display was firstly requested after the activation of the display device 1 (i.e., at the first calibration process). In another example, each time the display is requested, the control unit 17 may re-set the device coordinate system based on the position and posture of the display device 1 when the display is requested (i.e., at the calibration process). In this instance, the position/posture change quantity Ap does not need to be used in the generation process of the coordinate transformation information Ic to be described later.

FIG. 16 is an example of a flowchart illustrating a detailed processing procedure of the calibration process at step S15 in FIG. 15.

First, based on the captured image Im acquired from the sensor data storage unit 20 or the like, the feature extraction unit 42 of the control unit 17 generates the feature point information IF indicating sets of the extracted feature position and its candidate label corresponding to each structural feature point of the first structural feature point group (step S21). In this instance, the feature extraction unit 42 configures the feature extractor based on the parameters acquired from the parameter storage unit 21 and inputs the captured image Im to the feature extractor. Then, the feature extraction unit 42 generates the feature point information IF based on the information outputted by the feature extractor.

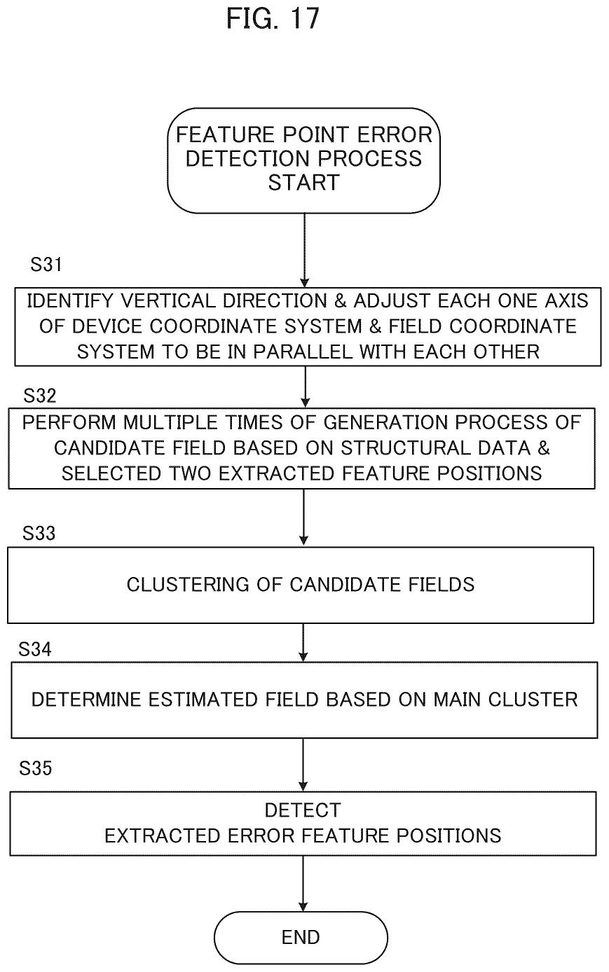

Next, the field estimation unit 46 of the coordinate transformation information generation unit 43 performs a feature point error detection process (step S22). Details of the feature point error detection process will be described with reference to FIG. 17.

Furthermore, the field estimation unit 46 executes the first field estimation process (step S23).

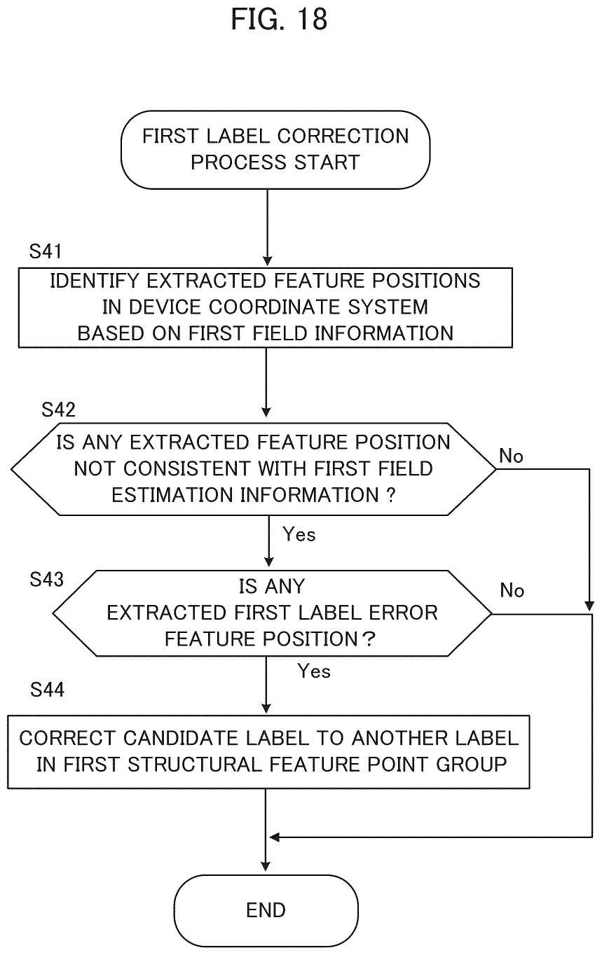

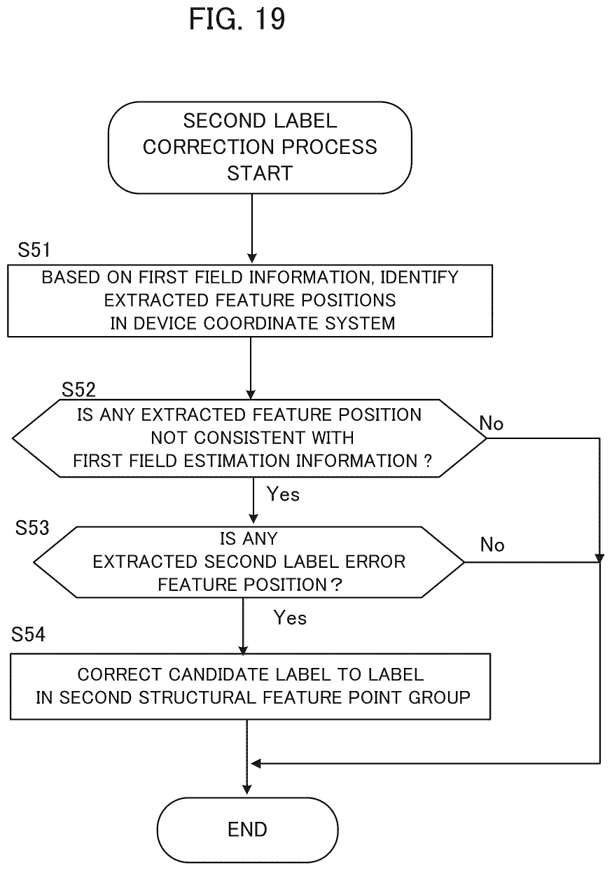

Then, the field estimation unit 46 executes the first label correction process by the first correction unit 55 and the second label correction process by the second correction unit 56 (step S24). Details of the first label correction process and the second label correction process will be described with reference to FIGS. 18 and 19. The first label correction process and the second label correction process may be performed in no particular order, and may be performed in parallel.

Then, the field estimation unit 46 executes the second field estimation process (step S25). Accordingly, the field estimation unit 46 generates the second field estimation information representing the highly accurate estimate of the display target field in the device coordinate system based on the feature point information IF in which the error is corrected.

Then, based on the second field estimation information generated by the field estimation unit 46, the coordinate transformation information generation unit 43 generates coordinate transformation information Ic for transforming a position in the device coordinate system into a position in the field coordinate system (step S26). In this case, the coordinate transformation information generation unit 43 matches, for each label, the detected position of the structural feature point indicated by the second field estimation information acquired at step S25 with the position of the structural feature point in the field coordinate system indicated by the registered position information included in the first structural data and the second structural data, and then calculates the coordinate transformation information Ic such that the matched positions coincide with each other (that is, the error between the positions for each label is minimized).

Thus, in the calibration process, the display device 1 matches the information obtained by extracting only structural feature points registered in advance (i.e., labelled in advance) from the captured image Im with the information of the structural feature points registered in the first structural data and the second structural data. Thus, the computational complexity required for the matching process to calculate the coordinate transformation information Ic can be greatly reduced, and the robust coordinate transformation information Ic can be calculated without being affected by extracting the noises (i.e., the feature points other than the display target field) included in the captured image Im. Further, in the present example, since the above-described matching is performed based on the estimated information of the structural feature points in which the error generated in the feature extraction process is suitably modified, the accurate coordinate transformation information Ic can be calculated.

FIG. 17 is an example of the flowchart illustrating details of the feature point error detection process that is executed at step S22.

First, the feature point error detection unit 51 identifies the vertical direction based on the output signal or the like from the acceleration sensor 160, and adjusts the device coordinate system or the like so that one axis (y-axis and y\hat{ }-axis) of the device coordinate system and the field coordinate system is parallel to each other based on the identified vertical direction (step S31).

Next, the feature point error detection unit 51 executes multiple times of a process of generating a candidate field in the device coordinate system, on the basis of the first structural data and selected two extracted feature positions (step S32). Thus, candidate fields in accordance with the number of times of the above-described processing execution are generated. The feature point error detection unit 51 may execute the multiple processes of generating the candidate field in parallel.

Next, the feature point error detection unit 51 generates clusters of the candidate fields generated at step S32 (step S33). In this case, the feature point error detection unit 51 generates one or more clusters of the candidate fields using any clustering technique.

The feature point error detection unit 51 determines the estimated field, based on the candidate fields of the main cluster having the largest number of the candidate fields (step S34). Then, the feature point error detection unit 51 detects one or more extracted error feature positions by projecting each extracted feature position onto the estimated field and comparing the projected extracted feature position with the structural feature point of the estimated field for each label (step S35).

FIG. 18 is an example of a flowchart showing the detailed description of the first label correction process performed at step S24.

First, the first correction unit 55 identifies the extracted feature positions in the device coordinate system on the basis of the first field estimation information generated by the first field estimation unit 52 (step S41). Then, the first correction unit 55 determines whether or not there is an extracted feature position that is not consistent with the first field estimation information (step S42). In this case, for example, if there is an extracted error feature position detected at step S35, the first correction unit 55 determines that there is an extracted feature position that is not consistent with the first field estimation information. In another example, the first correction unit 55 determines the presence or absence of the above-described extracted error feature position by comparing the positions and their labels of respective structural feature points identified from the first field estimation information with the extracted feature positions and their labels in the device coordinate system. Then, if there is no extracted feature position that is not consistent with the first field estimation information (step S42; No), the first correction unit 55 terminates the process of the flowchart since there is no need to correct the feature point information IF.

On the other hand, if there is an extracted feature position that is not consistent with the first field estimation information (step S42; Yes), the first correction unit 55 determines whether or not there is an extracted first label error feature position (step S43). Upon determining that there is an extracted first label error feature position (step S43; Yes), the first correction unit 55 corrects the candidate label of the extracted first label error feature position to be a label representing another structural feature point (specifically, the nearest structural feature point) of the first structural feature point group (step S44). Thereafter, the first correction unit 55 generates the feature point information IF in which the correction of the candidate labels at step S44 is reflected. On the other hand, upon determining that there is no first label error extracted feature position (step S43; No), the first correction unit 55 terminates the process of the flowchart.

FIG. 19 is an example of the flowchart indicating a second label correction process performed at step S24.

First, the second correction unit 56 identifies the extracted feature positions in the device coordinate system, on the basis of the first field estimation information generated by the first field estimation unit 52 (step S51). Then, the second correction unit 56 determines whether or not there is an extracted feature position that is not consistent with the first field estimation information (step S52). In this case, for example, if there is an extracted error feature position detected at step S35, the second correction unit 56 determines that there is an extracted feature position that is not consistent with the first field estimation information. In another example, the second correction unit 56 determines the presence or absence of the above-described extracted error feature position by comparing the positions and their labels of respective structural feature points identified from the first field estimation information with the extracted feature positions and their labels in the device coordinate system. In yet another example, the second correction unit 56 makes the determination at step S52 based on the determination result at step S42 in the first label correction process. Then, if there is no extracted feature position that is not consistent with the first field estimation information (step S52; No), the second correction unit 56 terminates the process of the flowchart since there is no need to correct the feature point information IF.

On the other hand, if there is an extracted feature position that is not consistent with the first field estimation information (step S52; Yes), the second correction unit 56 determines whether or not there is an extracted second label error feature position (step S53). Upon determining that there is an extracted second label error feature position (step S53; Yes), the second correction unit 56 corrects the candidate label of the extracted second label error feature position to the label of the corresponding structural feature point (i.e., the nearest structural feature point) in the second structural feature point group (step S54). Thereafter, the second correction unit 56 generates the feature point information IF in which the correction of the candidate labels at step S54 is reflected. On the other hand, upon determining that there is no second label error extracted feature position (step S53; No), the second correction unit 56 terminates the process of the flowchart.

If there is an extracted feature position whose candidate label is not corrected at step S44 nor step S54 among extracted feature positions determined not to be consistent with the first field estimation information ate step S42 or step S52, the label correction unit 53 determines that the extracted feature position is mistakenly estimated. Then, the label correction unit 53 performs a process such as deleting the extracted feature position from the feature point information IF or adding a flag indicating that the extracted feature position is an extracted error feature position.

(6) Modification The label correction unit 53 may have only a function corresponding to the second correction unit 56. Even in this case, the label correction unit 53 sufficiently secures the number of the structural feature points used for field estimation by correcting a candidate label to a label corresponding to a structural feature point of the second structural feature point group, and can perform the field estimation with high accuracy. The field estimation unit 46 may not have a function corresponding to the feature point error detection unit 51. In this case, the label correction unit 53 corrects the candidate label according to the flowchart shown in FIG. 19 based on the first field estimation information indicating the estimation result of the display target field roughly estimated by the first field estimation unit 52.

### Second Example Embodiment

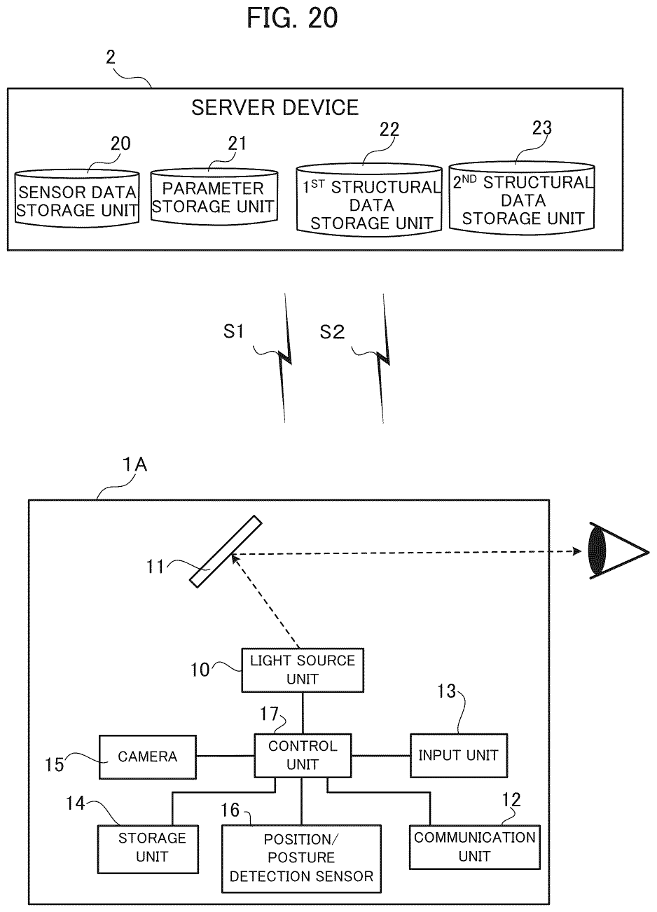

FIG. 20 shows a configuration of a display system in the second example embodiment. As shown in FIG. 20, the display system according to the second example embodiment includes a display device 1A and a server device 2. The second example embodiment are different from the first example embodiment in that the server device 2 executes the calibration process and the like instead of the display device 1A. Hereinafter, the same components as those in the first example embodiment are appropriately denoted by the same reference numerals, and a description thereof will be omitted.

The display device 1A transmits an upload signal “S1”, which is information required for the server device 2 to perform the calibration process or the like, to the server device 2. In this instance, the upload signal S1 includes a position/posture change amount Ap that is detected based on the captured image Im generated by the camera 15 and the output from the position/posture detection sensor 16. Upon receiving the distribution signal “S2” transmitted from the server device 2, the display device 1A performs light emission control of the light source unit 10 based on the distribution signal S2 to display the virtual object. For example, the distribution signal S2 includes information equivalent to the display signal Sd in the first example embodiment. Upon receiving the distribution signal S2, the display device 1A performs the same process as the light source control unit 45 does in the first example embodiment to control the light source unit 10 to emit light for displaying a virtual object.

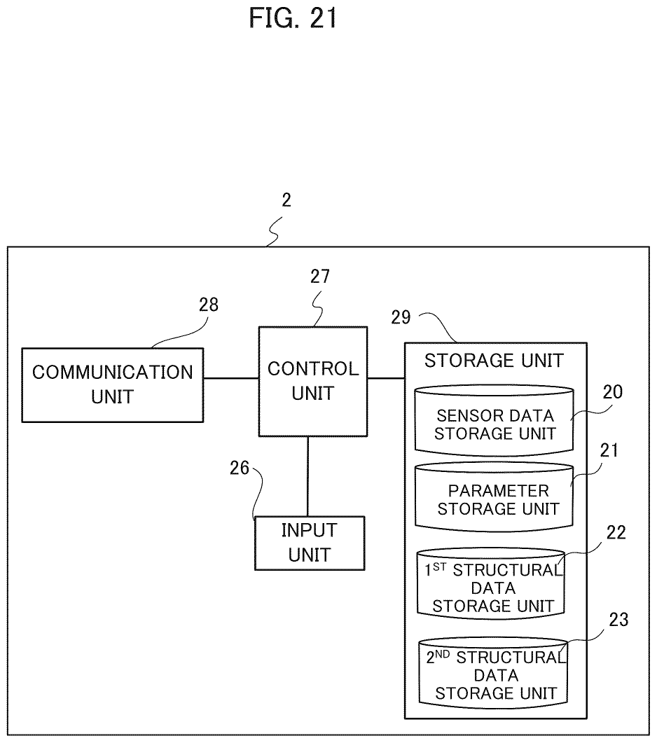

The server device 2 is, for example, a server device managed by a promoter, and generates the distribution signal S2 and distributes the distribution signal S2 to the display device 1A, based on the upload signal S1 received from the display device 1A. FIG. 21 is a block diagram of the server device 2. The server device 2 includes an input unit 26, a control unit 27, a communication unit 28, and a storage unit 29.

The storage unit 29 is a non-volatile memory in which the control unit 27 stores various information necessary for controlling the server device 2. The storage unit 29 stores a program to be executed by the control unit 27. The storage unit 29 includes a sensor data storage unit 20, a parameter storage unit 21, a first structural data storage unit 22, and a second structural data storage unit 23. Under the control of the control unit 27, the captured image Im and the position/posture change amount Ap included in the upload signal S1 are stored in the sensor data storage unit 20. The storage unit 29 may be an external storage device such as a hard disk connected or built in to the server device 2, or may be a storage medium such as a flash memory. The storage unit 29 may be a server device for performing data communication with the server device 2 (i.e., a device for storing information subject to reference from other devices). In this case, the storage unit 29 may be configured by a plurality of server devices to have the sensor data storage unit 20, the parameter storage unit 21, the first structural data storage unit 22, the second structural data storage unit 23 in a dispersed way.

The control unit 27 includes, for example, a processor such as a CPU and a GPU, a volatile memory that functions as a working memory, and performs overall control of the server device 2. Based on the user input to the input unit 26, the control unit 27 generates information (i.e., information corresponding to the specified display information Id in the first example embodiment) regarding the virtual object and the display position to be displayed as a virtual object. Furthermore, the control unit 27 executes a calibration process and generates a distribution signal S2 by referring to the sensor data storage unit 20, the parameter storage unit 21, the first structural data storage unit 22, and the second structural data storage unit 23. As described above, the control unit 27 is equipped with functions corresponding to the virtual object acquisition unit 41, the feature extraction unit 42, the coordinate transformation information generation unit 43, and the reflection unit 44 illustrated in FIG. 2.

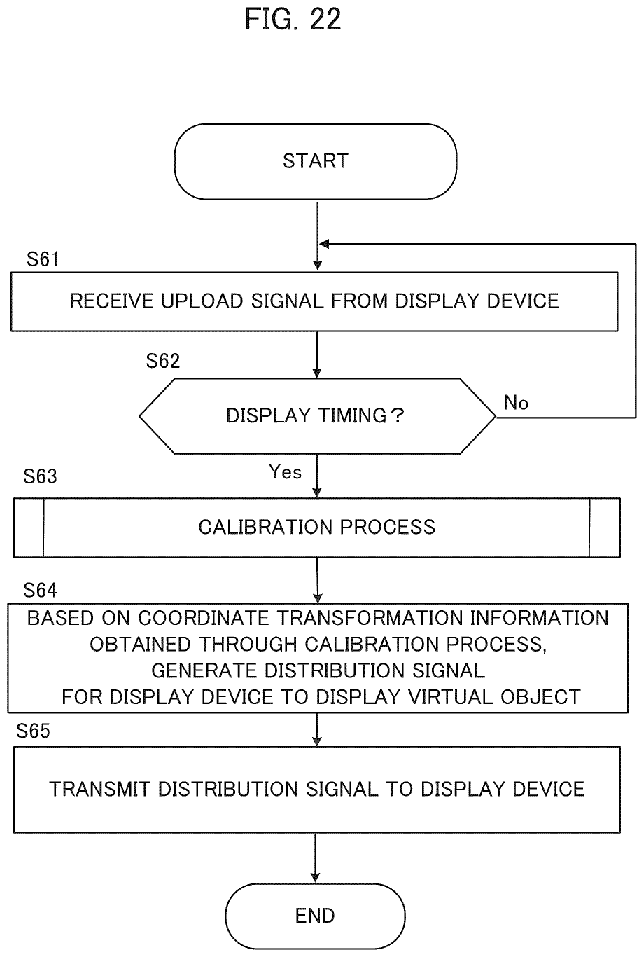

FIG. 22 is an example of a flowchart showing a processing procedure executed by the control unit 27 of the server device 2 in the second example embodiment.

First, the control unit 27 receives an upload signal S1 including the captured image Im and the position/posture change amount Ap from the display device 1A through the communication unit 28 (step S61). In this instance, the control unit 27 updates data to be stored in the sensor data storage unit 20 based on the upload signal S1. Then, the control unit 27 determines whether or not to display the virtual object (step S62). Upon determining not to display the virtual object (step S62; No), the control unit 27 receives the upload signal S1 from the display device 1A at step S61.

On the other hand, upon determining to display the virtual object (step S62; Yes), the control unit 27 executes the calibration process, based on the most recent upload signal S1 received at the step S61. In this case, the control unit 27 executes the flowchart shown in FIG. 16. Then, on the basis of the coordinate transformation information Ic obtained by the calibration process, the control unit 27 generates a distribution signal S2 for the display device 1A to display the virtual object (step S64). The control unit 27 transmits the generated distribution signal S2 to the display device 1A by the communication unit 28 (step S65). Thereafter, the display device 1A that has received the distribution signal S2 displays the virtual object by controlling the light source unit 10 based on the distribution signal S2.

As described above, according to the second example embodiment, the display system accurately calculates the coordinate transformation information Ic required for display of the virtual object by the display device 1A, thereby enabling the user to visually recognize the virtual object.

In the second example embodiment, the display device 1A may perform the calibration process in place of the server device 2. In this instance, the display device 1A performs processing of the flowchart shown in FIG. 16 by appropriately receiving information required for the calibration process from the server device 2. Even in this mode, the display system can allow the user of the display device 1A to suitably visually-recognize the virtual object.

### Third Example Embodiment

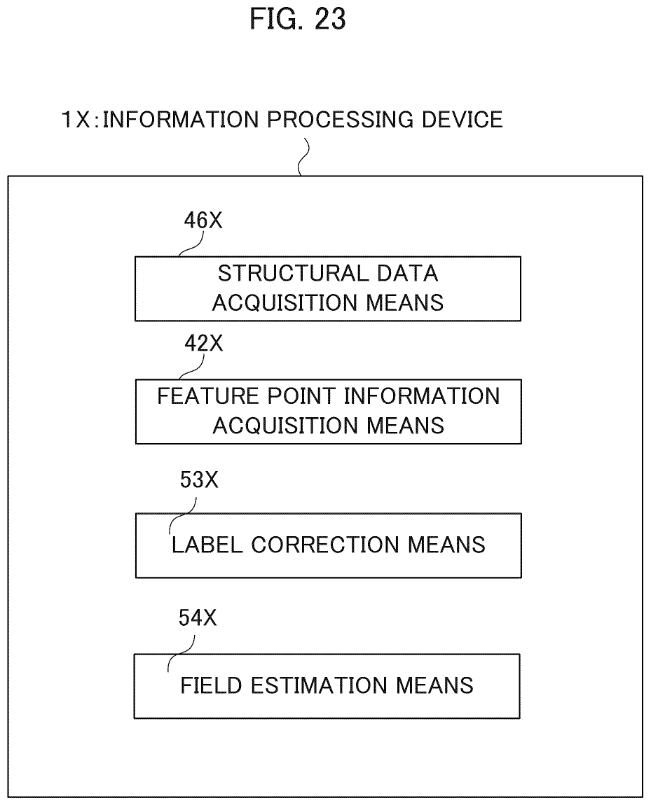

FIG. 23 shows a schematic configuration of an information processing device 1X according to a third example embodiment. As shown in FIG. 23, the information processing device 1X mainly includes a structural data acquisition means 46X, a feature point information acquisition means 42X, a label correction means 53X, and a field estimation means 54X. Examples of the information processing device 1X include the display device 1 or the control unit 17 of the display device 1 in the first example embodiment, and the control unit 27 of the server device 2 in the control unit 17 in the second example embodiment. The information processing device 1X may be configured by a plurality of device.

The structural data acquisition means 46X is configured to acquire first structural data regarding a first feature point group defined as feature points to be extracted from a target field, and second structural data regarding a second feature point group other than the first feature point group. Examples of the first feature point group include the first structural feature point group in the first example embodiment or the second example embodiment, and examples of the second feature point group include the second structural feature point group in the first example embodiment or the second example embodiment. Examples of the structural data acquisition means 46X include the field estimation unit 46 in the first example embodiment or the second example embodiment.

The feature point information acquisition means 42X is configured to acquire feature point information indicating sets of a position on an image and a candidate label thereof indicating a correspondence to a feature point of the first feature point group, the sets being determined based on the image which includes at least a part of the field. Examples of the “position on the image” include an extracted feature position in the first example embodiment or the second example embodiment. The feature point information acquisition means 42X may receive the feature point information generated by a processing block (including a device other than the information processing device 1X) other than the feature point information acquisition means 42X, or the feature point information acquisition means 42X may generate the feature point information instead. In the latter case, examples of the feature point information acquisition means 42X include the feature extraction unit 42 in the first example embodiment or the second example embodiment.

The label correction means 53X is configured to identify, based on the second structural data, a set of the position on the image and the candidate label corresponding to a feature point of the second feature point group, and generate corrected feature point information in which the identified candidate label is corrected to be a label indicating the feature point of the second feature point group. Examples of the label correction means 53X include the label correction unit 53 (particularly the second correction unit 56) in the first example embodiment or the second example embodiment.

The field estimation means 54X is configured to estimate, based on the first structural data, the second structural data, and the corrected feature point information, the field in a coordinate system to be used as a reference by a display device, which is equipped with a camera for capturing an image. Examples of the field estimation means 54X include the second field estimation unit 54 according to the first example embodiment or the second example embodiment.

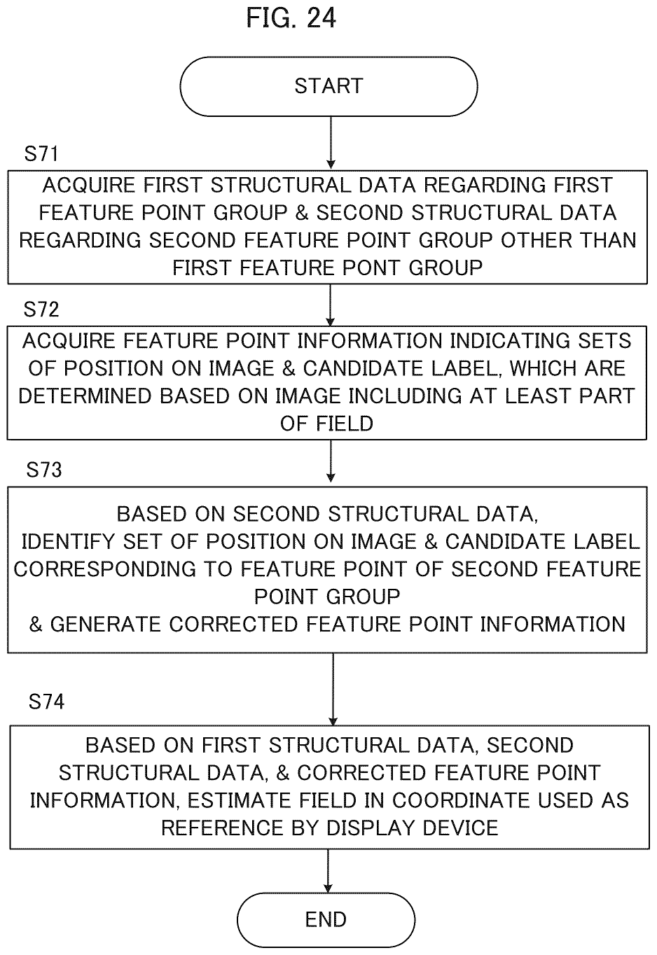

FIG. 24 is an example of a flowchart in the third example embodiment. The structural data acquisition means 46X acquires first structural data regarding a first feature point group defined as feature points to be extracted from a target field, and second structural data regarding a second feature point group other than the first feature point group (step S71). The feature point information acquisition means 42X acquires feature point information indicating sets of a position on an image and a candidate label thereof indicating a correspondence to a feature point of the first feature point group, the sets being determined based on the image which includes at least a part of the field (step S72). The label correction means 53X identifies, based on the second structural data, a set of the position on the image and the candidate label corresponding to a feature point of the second feature point group, and generate corrected feature point information in which the identified candidate label is corrected to be a label indicating the feature point of the second feature point group (step S73). The field estimation means 54X estimates, based on the first structural data, the second structural data, and the corrected feature point information, the field in a coordinate system to be used as a reference by a display device, which is equipped with a camera for capturing an image (step S74).

According to the third example embodiment, the information processing device 1X suitably corrects the feature point information and improves the estimation accuracy of the field in the coordinate system to be used as a reference by the display device.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above can be described as, but not limited to, the following Supplementary Notes.

### [Supplementary Note 1]

An information processing device comprising:
a structural data acquisition means configured to acquire
   first structural data regarding a first feature point group defined as feature points to be extracted from a target field, and
   second structural data regarding a second feature point group other than the first feature point group;
a feature point information acquisition means configured to acquire feature point information indicating sets of a position on an image and a candidate label thereof indicating a correspondence to a feature point of the first feature point group,
   the sets being determined based on the image which includes at least a part of the field;
a label correction means configured to
   identify, based on the second structural data, a set of the position on the image and the candidate label corresponding to a feature point of the second feature point group, and
   generate corrected feature point information in which the identified candidate label is corrected to be a label indicating the feature point of the second feature point group; and
a field estimation means configured to estimate,
   based on the first structural data, the second structural data, and the corrected feature point information,
   the field in a coordinate system to be used as a reference by a display device, which is equipped with a camera for capturing the image.

### [Supplementary Note 2]

The information processing device according to Supplementary Note 1,
wherein the field estimation means comprises:
   a first field estimation means configured to generate,
      based on the first structural data and the feature point information,
      first field estimation information indicating a first estimation result of the field in the coordinate system; and
   a second field estimation means configured to generate,
      based on the first structural data, the second structural data, and the corrected feature point information,
      second field estimation information indicating a second estimation result of the field in the coordinate system, and
wherein the label correction means is configured to identify,
   based on the first field estimation information and the second structural data,
   the set of the position on the image and the candidate label corresponding to the feature point of the second feature point group.

### [Supplementary Note 3]

The information processing device according to Supplementary Note 2 further comprising
a feature point error detection means configured to detect, based on the feature point information and the first structural data, a set of the position on the image and the candidate label
which is not consistent with any feature point of the first feature point group, wherein the first field estimation means is configured to generate the first field estimation information, based on a detection result by the feature point error detection means, the first structural data, and the feature point information.

### [Supplementary Note 4]

The information processing device according to Supplementary Note 2 or 3,
wherein the label correction means is configured to correct the candidate label,
   based on a distance between
      a projected position obtained by projecting the position on the image onto the coordinate system based on a photographing position and a parameter of the camera and
      the feature point of the second feature point group represented in the coordinate system based on the second structural data and the first field estimation information.

### [Supplementary Note 5]

The information processing device according to any one of Supplementary Notes 1 to 4,
wherein a display target field which is the field includes the first feature point group as common feature points also included in a training field displayed in an image for training a feature extractor, which is used in generating the feature point information, and
wherein the display target field is a field whose feature points includes the first feature point group and the second feature point group.

### [Supplementary Note 6]

The information processing device according to any one of Supplementary Notes 1 to 4,
wherein a display target field which is the field includes same feature points as a training field displayed in an image for training a feature extractor, which is used in generating the feature point information, and
wherein the second feature point group is a group of candidate positions to be erroneously extracted in generating the feature point information.

### [Supplementary Note 7]

The information processing device according to any one of Supplementary Notes 1 to 6, further comprising
a coordinate transformation information generation means configured to generate, based on an estimation result of the field, coordinate transformation information regarding coordinate transformation between
   a first coordinate system that is the coordinate system and
   a second coordinate system that is a coordinate system adopted in the first structural data and the second structural data.

### [Supplementary Note 8]

The information processing device according to any one of Supplementary Notes 1 to 7,
wherein the information processing device is the display device for displaying a virtual object superimposed on a scenery and comprises:
   a light source unit configured to emit a display light for displaying the virtual object; and
   an optical element configured to reflect at least a part of the display light to cause an observer to visually recognize the virtual object superimposed on the scenery.

### [Supplementary Note 9]

A control method executed by a computer, the control method comprising:
acquiring
   first structural data regarding a first feature point group defined as feature points to be extracted from a target field, and
   second structural data regarding a second feature point group other than the first feature point group;
acquiring feature point information indicating sets of a position on an image and a candidate label thereof indicating a correspondence to a feature point of the first feature point group,
   the sets being determined based on the image which includes at least a part of the field;
identifying, based on the second structural data, a set of the position on the image and the candidate label corresponding to a feature point of the second feature point group, and
generating corrected feature point information in which the identified candidate label is corrected to be a label indicating the feature point of the second feature point group; and
estimating,
   based on the first structural data, the second structural data, and the corrected feature point information,
   the field in a coordinate system to be used as a reference by a display device, which is equipped with a camera for capturing the image.

### [Supplementary Note 10]

A storage medium storing a program executed by a computer, the program causing the computer to:
acquire
   first structural data regarding a first feature point group defined as feature points to be extracted from a target field, and
   second structural data regarding a second feature point group other than the first feature point group;
acquire feature point information indicating sets of a position on an image and a candidate label thereof indicating a correspondence to a feature point of the first feature point group,
   the sets being determined based on the image which includes at least a part of the field;
identify, based on the second structural data, a set of the position on the image and the candidate label corresponding to a feature point of the second feature point group, and
generate corrected feature point information in which the identified candidate label is corrected to be a label indicating the feature point of the second feature point group; and
estimate,
   based on the first structural data, the second structural data, and the corrected feature point information,
   the field in a coordinate system to be used as a reference by a display device, which is equipped with a camera for capturing the image.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1A Display device
1X, 1Y Information processing device
2 Server device
10 Light source unit
11 Optical element
12 Communication unit
13 Input unit
14 Storage unit
15 Camera
16 Position/posture detection sensor
20 Sensor data storage unit
21 Parameter storage unit
22 First structural data storage unit
23 Second structural data storage unit

What is claimed is:

1. An information processing device comprising:
at least one memory configured to store instructions; and
at least one processor configured to execute the instructions to:
acquire
first structural data regarding a first feature point group defined as feature points to be extracted from a target field, and
second structural data regarding a second feature point group other than the first feature point group;
acquire feature point information indicating sets of a position on an image and a candidate label thereof indicating a correspondence to a feature point of the first feature point group,
the sets being determined based on the image which includes at least a part of the field;
identify, based on the second structural data, a set of the position on the image and the candidate label corresponding to a feature point of the second feature point group, and
generate corrected feature point information in which the identified candidate label is corrected to be a label indicating the feature point of the second feature point group; and
estimate,
based on the first structural data, the second structural data, and the corrected feature point information,
the field in a coordinate system to be used as a reference by a display device, which is equipped with a camera for capturing the image.

2. The information processing device according to claim 1,
wherein the at least one processor is configured to execute the instructions to:
generate,
based on the first structural data and the feature point information,
first field estimation information indicating a first estimation result of the field in the coordinate system; and
generate,
based on the first structural data, the second structural data, and the corrected feature point information,
second field estimation information indicating a second estimation result of the field in the coordinate system, and
wherein the at least one processor is configured to execute the instructions to identify,
based on the first field estimation information and the second structural data,
the set of the position on the image and the candidate label corresponding to the feature point of the second feature point group.

3. The information processing device according to claim 2,
wherein the at least one processor is configured to further execute the instructions to detect, based on the feature point information and the first structural data, a set of the position on the image and the candidate label which is not consistent with any feature point of the first feature point group,
wherein the at least one processor is configured to execute the instructions to generate the first field estimation information, based on a detection result, the first structural data, and the feature point information.

4. The information processing device according to claim 2,
wherein the at least one processor is configured to execute the instructions to correct the candidate label,
based on a distance between
a projected position obtained by projecting the position on the image onto the coordinate system based on a photographing position and a parameter of the camera and
the feature point of the second feature point group represented in the coordinate system based on the second structural data and the first field estimation information.

5. The information processing device according claim 1,
wherein a display target field which is the field includes the first feature point group as common feature points also included in a training field displayed in an image for training a feature extractor, which is used in generating the feature point information, and
wherein the display target field is a field whose feature points includes the first feature point group and the second feature point group.

6. The information processing device according to claim 1,
wherein a display target field which is the field includes same feature points as a training field displayed in an image for training a feature extractor, which is used in generating the feature point information, and
wherein the second feature point group is a group of candidate positions to be erroneously extracted in generating the feature point information.

7. The information processing device according to claim 1,
wherein the at least one processor is configured to further execute the instructions to generate, based on an estimation result of the field, coordinate transformation information regarding coordinate transformation between
a first coordinate system that is the coordinate system and
a second coordinate system that is a coordinate system adopted in the first structural data and the second structural data.

8. The information processing device according to claim 1,
wherein the information processing device is the display device for displaying a virtual object superimposed on a scenery and comprises:
a light source configured to emit a display light for displaying the virtual object; and
an optical element configured to reflect at least a part of the display light to cause an observer to visually recognize the virtual object superimposed on the scenery.

9. A control method executed by a computer, the control method comprising:
acquiring
first structural data regarding a first feature point group defined as feature points to be extracted from a target field, and
second structural data regarding a second feature point group other than the first feature point group;
acquiring feature point information indicating sets of a position on an image and a candidate label thereof indicating a correspondence to a feature point of the first feature point group,
the sets being determined based on the image which includes at least a part of the field;
identifying, based on the second structural data, a set of the position on the image and the candidate label corresponding to a feature point of the second feature point group, and
generating corrected feature point information in which the identified candidate label is corrected to be a label indicating the feature point of the second feature point group; and
estimating,
based on the first structural data, the second structural data, and the corrected feature point information,
the field in a coordinate system to be used as a reference by a display device, which is equipped with a camera for capturing the image.

10. A non-transitory computer readable storage medium storing a program executed by a computer, the program causing the computer to:
acquire
first structural data regarding a first feature point group defined as feature points to be extracted from a target field, and
second structural data regarding a second feature point group other than the first feature point group;
acquire feature point information indicating sets of a position on an image and a candidate label thereof indicating a correspondence to a feature point of the first feature point group,
the sets being determined based on the image which includes at least a part of the field;
identify, based on the second structural data, a set of the position on the image and the candidate label corresponding to a feature point of the second feature point group, and
generate corrected feature point information in which the identified candidate label is corrected to be a label indicating the feature point of the second feature point group; and
estimate,
based on the first structural data, the second structural data, and the corrected feature point information,
the field in a coordinate system to be used as a reference by a display device, which is equipped with a camera for capturing the image.
